(19) United States
(12) Patent Application Publication
(10) Pub. No.: US 2018/0080226 A1
(43) Pub. Date: Mar. 22, 2018

(54) GYPSUM BOARDS WITH POLYMER COATING AND METHODS FOR MAKING SAME

(71) Applicant: UNITED STATES GYPSUM COMPANY, Chicago, IL (US)

(72) Inventors: Runhai LU, Wauconda, IL (US); Evan V. ROHLF, Tower Lakes, IL (US)

(21) Appl. No.: 15/485,671

(22) Filed: Apr. 12, 2017

Related U.S. Application Data
(60) Provisional application No. 62/398,194, filed on Sep. 22, 2016.

(51) Int. Cl. E04C 2/04; B28B 19/00; B28B 11/04; C01F 11/46; C04B 11/00; C04B 38/10; C09D 5/02; C09D 131/04; C09D 127/06; C09D 109/08

(52) U.S. Cl. CPC E04C 2/04; C04B 2111/0062; B28B 11/04; C01F 11/466; C04B 11/00; C04B 38/10; C09D 5/027; C09D 5/028; C09D 131/04; C09D 127/06; C09D 109/08; C01P 2006/10; C01P 2006/14; C04B 2201/20; B28B 19/0092

(57) ABSTRACT

A gypsum board provided with a foamed gypsum core layer, a facing sheet over the foamed gypsum core, and a latex polymer coating layer on an outer surface of the facing sheet. The latex polymer having a glass transition temperature (Tg) of 0 to 35° F. Methods for making the board are also disclosed.

### FIELD OF THE INVENTION

This invention relates to a method and composition for preparing set gypsum-containing products, e.g., gypsum boards, and methods for producing them. More particularly, the invention concerns such set gypsum-containing products having a polymer coating penetrating the face sheet.

### BACKGROUND

Typically, gypsum-containing cementitious products are made by preparing a mixture of calcined gypsum (calcium sulfate alpha or beta hemihydrate and/or calcium sulfate anhydrite), water, and other components, as appropriate to form cementitious slurry. In the manufacture of cementitious articles, the cementitious slurry and desired additives are often blended in a continuous mixer, as for example described in U.S. Pat. No. 3,359,146. For example, in a typical gypsum panel manufacturing process, gypsum board is produced by uniformly dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. The stream of slurry passes through the discharge conduit from which it is continuously deposited onto a moving web of cover sheet material supported by a forming table.

The slurry is allowed to spread over the advancing web. A second web of cover sheet material is applied to cover the slurry and form a sandwich structure of a continuous wallboard preform, which is subjected to forming, such as at a conventional forming station, to obtain a desired thickness.

The calcined gypsum reacts with the water in the wallboard preform and sets as a conveyor moves the wallboard preform down a manufacturing line. The wallboard preform is cut into segments at a point along the line where the preform has set sufficiently. The segments are flipped over, dried (e.g., in a kiln) to drive off excess water, and processed to provide the final wallboard product of desired dimensions.

Prior devices and methods for addressing the production of gypsum wallboard are disclosed in commonly-assigned U.S. Pat. Nos. 5,683,635; 5,643,510; 6,494,609; 6,874,930; 7,007,914; and 7,296,919, which are incorporated by reference.

WO 02/12144, also published as U.S. Pat. No. 7,208,225, teaches to apply a skim coating comprising water, mineral filler, and binder to one side of the board.

WO 02/58902, also published as US 2004/0154264 to Colbert, teaches applying a coating to a wet gypsum board prior to drying the gypsum board.

U.S. Pat. No. 6,663,979 teaches applying to a gypsum board either before or after drying of the board a coating including a binder, a soy protein, and two or more pigments.

U.S. Pat. No. 7,214,411 teaches a manufacturing line for gypsum boards including a conveyor for moving gypsum boards in a line, a spray arm having a pivot at one end thereof for supporting the spray arm in a pivotable manner.

U.S. Pat. No. 7,414,085 teaches a coating for wall construction whereby a level 5 finish may be obtained without the need for a finishing coat or final skim coat.

U.S. Pat. No. 7,469,510 teaches a coating applied to drywall elements prior to installation.

U.S. Pat. No. 8,151,532 teaches including a coating layer formed of at least one skim coat deposited on the prefabricated elements of a construction assembly.

U.S. Pat. No. 8,524,373 teaches gypsum plasterboard with a covering paper forming the outside of the plasterboard and a coating slip deposited on the covering paper.

US 2010/0047461 to Colbert teaches a method of producing a coated gypsum board.

It will be appreciated that this background description has been created by the inventors to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein. Thus, there is a continuing need for new and improved set gypsum-containing products, and compositions and methods for producing them, that solve, avoid, or minimize a problem noted above.

### SUMMARY OF THE INVENTION

The present invention provides a gypsum board (also known as a gypsum panel) comprising:

a face paper sheet having an inner bond surface and an outer surface, the face paper sheet inner bond surface opposed to the face paper sheet outer surface, the face paper sheet treated with a polymer coating composition disposed on the entire outer surface of the face paper sheet to have a polymer coating,

wherein the polymer coating composition comprises a mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
preferably the polycarboxylate dispersant comprises a polycarboxylic ether dispersant,
preferably the naphthalene dispersant is selected from at least one of beta-naphthalene sulfonate, naphthalene sulfonate formaldehyde condensate and sodium naphthalene sulfate formaldehyde condensate,
preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
0.02 to 0.5 wt. % thickener selected from at least one member of the group consisting of a cellulose thickener and an acrylate thickener,
0.01 to 0.5 wt. % silicon based defoamer,
4.5 to 15 wt. %, preferably 4.8 to 6.5 wt. %, more preferably 4.8 to 5.2 wt. %, latex comprising latex polymer having a glass transition temperature (Tg) of 0 to 35° F., preferably 25 to 32° F., the latex polymer having a weight average molecular weight of 40,000 to 500,000, the latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex, the latex comprising 35 to 55 wt. % said latex polymer dispersed as solids in aqueous medium,
inorganic particles, wherein the inorganic particles are 28 to 50 wt. %, preferably 34.5 to 42 wt. %, of the polymer coating composition, wherein the inorganic particles have a combined average particle size of 0.7 to 4 microns, preferably 0.9 to 3.5 microns, most preferably 3 to 3.5 microns,
wherein the inorganic particles comprise,
   clay, wherein the clay is 0 to 17 wt. %, preferably 8 to 17 wt. %, more preferably 9.5 to 11 wt. %, of the polymer coating composition, wherein the clay has an average particle size of 0.3 to 3.7 microns, preferably the clay is calcined clay having average particle size of 2.8 to 3.5 microns,
   inorganic filler powder, wherein the inorganic filler powder is 20 to 45 wt. %, preferably 20 to 31 wt. %, more preferably 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.7 to 1.2 microns, preferably 0.8 to 1.0 microns, wherein the calcium sulfate dihydrate has an average particle size of 0.7 to 10 microns, preferably 2.5 to 4 microns,
   pigment particles, wherein the pigment particles are 0 to 10 wt. %, of the polymer coating composition, preferably the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.8 micron, preferably less than 0.9 micron, then the latex polymer is 1.8 to 2.1% of the coating composition on a water free basis, and
49 to 65 wt. % water, preferably 55 to 61 wt. % water, this water being in addition to water of the latex aqueous medium;

a backing paper sheet having an inner bond surface and an outer surface, the backing paper sheet inner bond surface opposed to the backing paper sheet outer surface;

a foamed gypsum core layer having opposed first and second sides, the foamed gypsum core layer between the face paper sheet inner bond surface and the backing paper sheet inner bond surface, the foamed gypsum core layer comprising calcium sulfate dihydrate, wherein the gypsum core layer has a thickness of 0.25 to 1 inches and a density of 15 to 55 pounds/cubic foot, wherein the foamed gypsum core layer has a total void volume of 30 to 90 volume percent;

wherein the polymer coating penetrates the outer surface of the face paper sheet a depth of 0 to 20% of thickness of the face paper sheet.

All of the above weight percent values being of the polymer coating composition unless otherwise indicated.

The slurry from which the gypsum core material was made was a mixture of water and calcium sulfate hemihydrate preferably at a water to calcium sulfate hemihydrate weight ratio of 0.2-1.5:1, more preferably 0.2-0.8:1, most preferably 0.4-0.7:1.

The invention also provides a method of making a gypsum board, comprising:

providing a face paper sheet having an inner bond surface and an outer surface, the face paper sheet inner bond surface opposed to the face paper sheet outer surface, the face paper sheet treated with a polymer coating composition disposed on the entire outer surface of the face paper sheet to have a polymer coating,
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
preferably the polycarboxylate dispersant comprises a polycarboxylic ether dispersant,
preferably the naphthalene dispersant is selected from at least one of beta-naphthalene sulfonate, naphthalene sulfonate formaldehyde condensate and sodium naphthalene sulfate formaldehyde condensate,
preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
0.02 to 0.5 wt. % thickener selected from at least one member of the group consisting of a cellulose thickener and an acrylate thickener,
0.01 to 0.5 wt. % silicon based defoamer,
4.5 to 15 wt. %, preferably 4.8 to 6.5 wt. %, more preferably 4.8 to 5.2 wt. %, latex comprising latex polymer having a glass transition temperature (Tg) of 0 to 35° F., preferably 25 to 32° F., the latex polymer having a weight average molecular weight of 40,000 to 500,000, the latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex, the latex comprising 35 to 55 wt. % said latex polymer dispersed as solids in aqueous medium,
inorganic particles, wherein the inorganic particles are 28 to 50 wt. %, preferably 34.5 to 42 wt. %, of the polymer coating composition, wherein the inorganic particles have a combined average particle size of 0.7 to 4 microns, preferably 0.9 to 3.5 microns, most preferably 3 to 3.5 microns,
wherein the inorganic particles comprise,
   clay, wherein the clay is 0 to 17 wt. %, preferably 8 to 17 wt. %, more preferably 9.5 to 11 wt. %, of the polymer coating composition, wherein the clay has an average particle size of 0.3 to 3.7 microns, preferably the clay is calcined clay having average particle size of 2.8 to 3.5 microns,
   inorganic filler powder, wherein the inorganic filler powder is 20 to 45 wt. %, preferably 20 to 31 wt. %, more preferably 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.7 to 1.2 microns, preferably 0.8 to 1.0 microns, wherein the calcium sulfate dihydrate has an average particle size of 0.7 to 10 microns, preferably 2.5 to 4 microns,
   pigment particles, wherein the pigment particles are 0 to 10 wt. %, of the polymer coating composition, preferably the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.8 micron, preferably less than 0.9 micron, then the latex polymer is 1.8 to 2.1% of the coating composition on a water free basis, and
49 to 65 wt. % water, preferably 55 to 61 wt. % water, this water being in addition to water of the latex aqueous medium;

mixing water, calcium sulfate hemihydrate and air to make a foamed gypsum slurry, wherein a weight ratio of the water to calcium sulfate hemihydrate being mixed is 0.2-1.5:1, preferably 0.2-0.8:1, more preferably 0.4-0.7:1;

depositing a layer of the foamed gypsum slurry over the face paper sheet inner bond surface;

depositing a backing paper sheet over the layer of the foamed gypsum slurry;

wherein calcium sulfate hemihydrate in the foamed gypsum slurry converts to calcium sulfate dihydrate and sets to form the gypsum board,

wherein the polymer coating penetrates the outer surface of the face paper sheet a depth of 0 to 20% of thickness of the face paper sheet,

wherein a foamed gypsum core layer resulting from the set foamed gypsum slurry has a thickness of 0.25 to 1 inches and a density of 15 to 55 pounds/cubic foot, wherein the foamed gypsum core layer has a total void volume of 30 to 90 volume percent.

All of the above weight percent values being of the polymer coating composition unless otherwise indicated.

The product and method of the invention preferably applies 1.5 to 5 pounds per thousand square feet (MSF) polymer coating to the face sheet on a dry (water free) basis, more preferably 3 to 4 pounds/MSF, most preferably 3.1 to 3.7 pounds/MSF. Likewise if the invention applied polymer coating to the backing sheet then the invention preferably applies 1.5 to 5 pounds per thousand square feet (MSF) polymer coating to the backing sheet on a dry (water free) basis, more preferably 3 to 4 pounds/MSF, most preferably 3.1 to 3.7 pounds/MSF.

The face paper outer surface may be pre-coated with the polymer coating composition to form the polymer layer. In the alternative the method further comprises applying the polymer coating composition to the outer surface of the face paper sheet during or after board manufacture. Likewise for the back paper sheet, if provided with optional polymer coating.

Preferably the polymer coating of the product and method has an absence of one or more (most preferably all) of magnesium carbonate, pigment other than titanium dioxide, and polyurea.

As used herein, the term, “calcined gypsum”, is intended to mean alpha calcium sulfate hemihydrate, beta calcium sulfate hemihydrate, water-soluble calcium sulfate anhydrite, or mixtures of any or all thereof, and the terms, “set gypsum” and “hydrated gypsum”, are intended to mean calcium sulfate dihydrate. The water in the mixture reacts spontaneously with the calcined gypsum to form set gypsum.

All percentages and ratios are by weight unless otherwise indicated. All molecular weights are weight average molecular weights unless otherwise indicated.

### DESCRIPTION OF THE DRAWINGS

FIG. 1 shows a gypsum board of the present invention.

FIG. 2 schematically shows a first arrangement for a board cross section.

FIG. 3 schematically shows a second arrangement for a board cross section

FIG. 4 shows a schematic of a portion of the layers of the board cross section of FIG. 2.

FIG. 5 shows a slurry mixer that may be employed with the present invention.

FIG. 6 shows a slurry distributor that may be employed with the present invention.

FIG. 7 shows a first embodiment of an apparatus for making a board of the present invention.

FIG. 8 shows a second embodiment of an apparatus for making a board of the present invention.

FIG. 9 shows a third embodiment of an apparatus for making a board of the present invention

### DESCRIPTION OF PREFERRED EMBODIMENTS

The present invention provides a gypsum board having a coated face paper sheet. The gypsum board has a core made from cementitious slurry material including any calcium sulfate hemihydrate, also known as stucco or calcined gypsum. The cementitious material is at least 50 wt % calcium sulfate hemihydrate. Preferably, the amount of calcium sulfate hemihydrate is at least 75 wt %, at least 80 wt % or at least 85 wt %. In many wallboard formulations, the hydraulic material is substantially all calcium sulfate hemihydrate. Any form of calcined gypsum may be used, including but not limited to alpha or beta stucco. Thus, the cementitious material comprises calcined gypsum, such as in the form of calcium sulfate alpha hemihydrate, calcium sulfate beta hemihydrate, and/or calcium sulfate anhydrite. The calcined gypsum can be fibrous in some embodiments and non-fibrous in others. The calcined gypsum can include at least about 50% beta calcium sulfate hemihydrate. In other embodiments, the calcined gypsum can include at least about 86% beta calcium sulfate hemihydrate. Use of calcium sulfate anhydrite, synthetic gypsum or landplaster is also contemplated, although preferably in small amounts of less than 20%. Other hydraulic materials, including cement and fly ash, are optionally included in the slurry.

The weight ratio of water to calcined gypsum can be any suitable ratio, although, as one of ordinary skill in the art will appreciate, lower ratios can be more efficient because less excess water must be driven off during manufacture, thereby conserving energy. Preferably the cementitious slurry is prepared by combining water and calcined gypsum (calcium sulfate hemihydrate) in a range from about a 1:6 ratio by weight respectively to about 1:1 ratio, more preferably 0.2-0.8:1, and most preferably 0.4-0.8:1, such as about 2:3, for board production depending on products.

A dispersant is present in the slurry in amounts from about 0.01% to about 2% by weight of the dry dispersant calculated as a percentage of the dry gypsum.

Preferably, the gypsum slurry for the core of a gypsum board of the invention is foamed to have 10 to 70 volume percent air, more preferably 20 to 60 volume percent air. The resulting board has 30 to 92% voids.

Gypsum Board and Method of Making

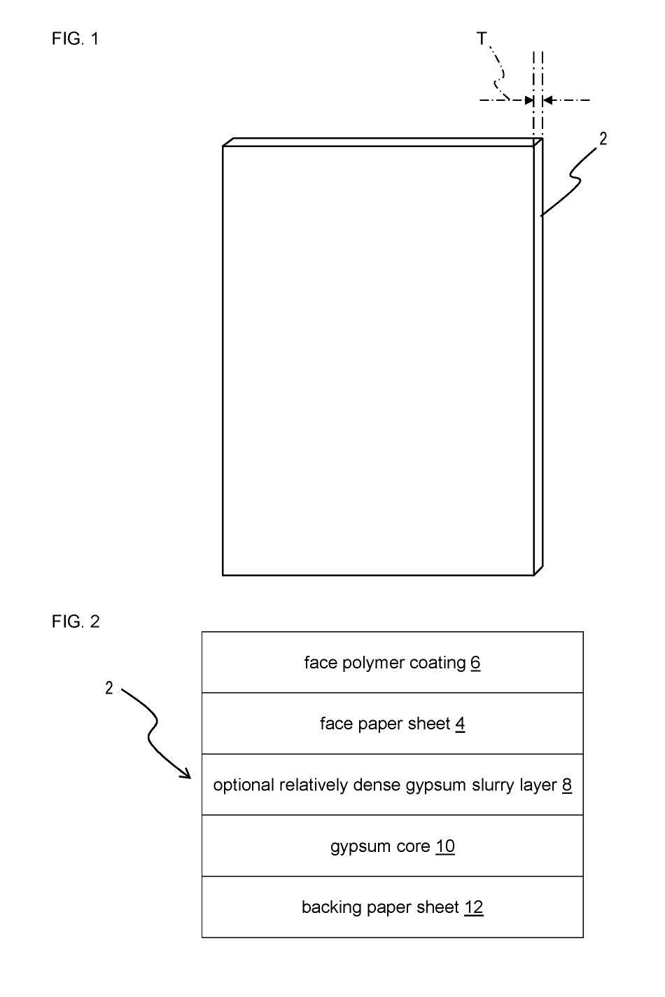

The method and composition of the invention are for preparing gypsum board 2 (see FIG. 1) comprising a core of set gypsum-containing material sandwiched between cover sheets.

FIG. 2 shows a first arrangement of the layers for the gypsum board 2. It has a face paper sheet 4, a face polymer coating 6, an optional relatively dense gypsum layer 8, a gypsum core 10, and a backing paper sheet 12.

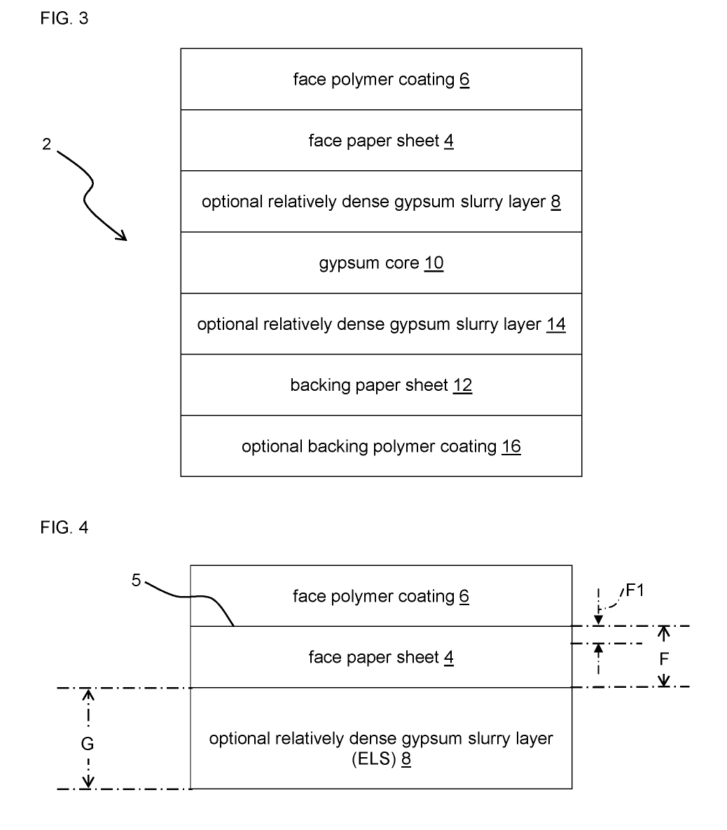

FIG. 3 shows a second arrangement of the layers for the gypsum board 2. It has the face paper sheet 4, the face polymer coating 6, the optional first relatively dense gypsum layer 8, the gypsum core 10, an optional second relatively dense gypsum layer 14, the backing paper sheet 12, and an optional backing polymer coating 16.

The present invention provides a gypsum board comprising:

a face paper sheet having an inner bond surface and an outer surface, the face paper sheet inner bond surface opposed to the face paper sheet outer surface, the face paper sheet treated with a polymer coating composition disposed on the entire outer surface of the face paper sheet to have a polymer coating,

wherein the polymer coating composition comprises a mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
preferably the naphthalene dispersant is selected from at least one of beta-naphthalene sulfonate, naphthalene sulfonate formaldehyde condensate and sodium naphthalene sulfate formaldehyde condensate,
preferably the polycarboxylate dispersant comprises a polycarboxylic ether dispersant, preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
0.02 to 0.5 wt. % thickener selected from at least one member of the group consisting of a cellulose thickener and an acrylate thickener,
0.01 to 0.5 wt. % silicon based defoamer,
4.5 to 15 wt. %, preferably 4.8 to 6.5 wt. %, more preferably 4.8 to 5.2 wt. %, latex comprising latex polymer having a glass transition temperature (Tg) of 0 to 35° F., preferably 25 to 32° F., the latex polymer having a weight average molecular weight of 40,000 to 500,000, the latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex, the latex comprising 35 to 55 wt. % said latex polymer dispersed as solids in aqueous medium,
inorganic particles, wherein the inorganic particles are 28 to 50 wt. %, preferably 34.5 to 42 wt. %, of the polymer coating composition, wherein the inorganic particles have a combined average particle size of 0.7 to 4 microns, preferably 0.9 to 3.5 microns, most preferably 3 to 3.5 microns,
wherein the inorganic particles comprise,
   clay, wherein the clay is 0 to 17 wt. %, preferably 8 to 17 wt. %, more preferably 9.5 to 11 wt. %, of the polymer coating composition, wherein the clay has an average particle size of 0.3 to 3.7 microns, preferably the clay is calcined clay having average particle size of 2.8 to 3.5 microns,
   inorganic filler powder, wherein the inorganic filler powder is 20 to 45 wt. %, preferably 20 to 31 wt. %, more preferably 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.7 to 1.2 microns, preferably 0.8 to 1.0 microns, wherein the calcium sulfate dihydrate has an average particle size of 0.7 to 10 microns, preferably 2.5 to 4 microns,
   pigment particles, wherein the pigment particles are 0 to 10 wt. %, of the polymer coating composition, preferably the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.8 micron, preferably less than 0.9 micron, then the latex polymer is 1.8 to 2.1% of the coating composition on a water free basis, and
49 to 65 wt. % water, preferably 55 to 61 wt. % water, this water being in addition to water of the latex aqueous medium;

a backing paper sheet having an inner bond surface and an outer surface, the backing paper sheet inner bond surface opposed to the backing paper sheet outer surface;

a foamed gypsum core layer having opposed first and second sides, the foamed gypsum core layer between the face paper sheet inner bond surface and the backing paper sheet inner bond surface, the foamed gypsum core layer comprising calcium sulfate dihydrate, wherein the gypsum core layer has a thickness of 0.25 to 1 inches and a density of 15 to 55 pounds/cubic foot, wherein the foamed gypsum core layer has a total void volume of 30 to 90 volume percent;

wherein the polymer coating penetrates the outer surface of the face paper sheet a depth of 0 to 20% of thickness of the face paper sheet.

The slurry from which the gypsum core material was made was a mixture of water and calcium sulfate hemihydrate preferably at a water to calcium sulfate hemihydrate weight ratio of 0.2-1.5:1, more preferably 0.2-0.8:1, most preferably 0.4-0.7:1. The board comprises the gypsum core sandwiched between the face paper sheet and a back paper sheet.

Optionally the gypsum board further comprises a first relatively dense gypsum layer comprising calcium sulfate dihydrate, wherein the first relatively dense gypsum layer is between the foamed gypsum core layer and the face paper sheet inner bond surface, wherein opposed sides of the first relatively dense gypsum layer respectively contact the foamed gypsum core layer and the face paper sheet inner bond surface; the first relatively dense gypsum layer having a density greater than density of the foamed gypsum core layer, the first layer of relatively dense gypsum being thinner than the foamed gypsum core layer, wherein the first layer of relatively dense gypsum has a total void volume of less than 30 volume percent.

Optionally the gypsum board further comprises a second relatively dense gypsum layer comprising calcium sulfate dihydrate, wherein the second relatively dense gypsum layer is between the foamed gypsum core layer and the backing paper sheet inner bond surface, wherein opposed sides of the second relatively dense gypsum layer respectively contact the foamed gypsum core layer and the backing paper sheet inner bond surface; the second relatively dense gypsum layer having a density greater than density of the foamed gypsum core layer, the second layer of relatively dense gypsum being thinner than the foamed gypsum core layer, wherein the second layer of relatively dense gypsum has a total void volume of less than 30 volume percent.

The invention also provides a method of making a gypsum board, comprising:

providing a face paper sheet having an inner bond surface and an outer surface, the face paper sheet inner bond surface opposed to the face paper sheet outer surface, the face paper sheet treated with a polymer coating composition disposed on the entire outer surface of the face paper sheet to have a polymer coating,

wherein the polymer coating composition comprises a mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
preferably the polycarboxylate dispersant comprises a polycarboxylic ether dispersant,
preferably the naphthalene dispersant is selected from at least one of beta-naphthalene sulfonate, naphthalene sulfonate formaldehyde condensate and sodium naphthalene sulfate formaldehyde condensate,
preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
0.02 to 0.5 wt. % thickener selected from at least one member of the group consisting of a cellulose thickener and an acrylate thickener,
0.01 to 0.5 wt. % silicon based defoamer,
4.5 to 15 wt. %, preferably 4.8 to 6.5 wt. %, more preferably 4.8 to 5.2 wt. %, latex comprising latex polymer having a glass transition temperature (Tg) of 0 to 35° F., preferably 25 to 32° F., the latex polymer having a weight average molecular weight of 40,000 to 500,000, the latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex, the latex comprising 35 to 55 wt. % said latex polymer dispersed as solids in aqueous medium,
inorganic particles, wherein the inorganic particles are 28 to 50 wt. %, preferably 34.5 to 42 wt. %, of the polymer coating composition, wherein the inorganic particles have a combined average particle size of 0.7 to 4 microns, preferably 0.9 to 3.5 microns, most preferably 3 to 3.5 microns,
wherein the inorganic particles comprise,
   clay, wherein the clay is 0 to 17 wt. %, preferably 8 to 17 wt. %, more preferably 9.5 to 11 wt. %, of the polymer coating composition, wherein the clay has an average particle size of 0.3 to 3.7 microns, preferably the clay is calcined clay having average particle size of 2.8 to 3.5 microns,
   inorganic filler powder, wherein the inorganic filler powder is 20 to 45 wt. %, preferably 20 to 31 wt. %, more preferably 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.7 to 1.2 microns, preferably 0.8 to 1.0 microns, wherein the calcium sulfate dihydrate has an average particle size of 0.7 to 10 microns, preferably 2.5 to 4 microns,
   pigment particles, wherein the pigment particles are 0 to 10 wt. %, of the polymer coating composition, preferably the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.8 micron, preferably less than 0.9 micron, then the latex polymer is 1.8 to 2.1% of the coating composition on a water free basis, and
49 to 65 wt. % water, preferably 55 to 61 wt. % water, this water being in addition to water of the latex aqueous medium;

mixing water, calcium sulfate hemihydrate and air to make a foamed gypsum slurry, wherein a weight ratio of the water to calcium sulfate hemihydrate being mixed is 0.2-1.5:1, preferably 0.2-0.8:1, more preferably 0.4-0.7:1;

depositing a layer of the foamed gypsum slurry over the face paper sheet inner bond surface;

depositing a backing paper sheet over the layer of the foamed gypsum slurry;

wherein calcium sulfate hemihydrate in the foamed gypsum slurry converts to calcium sulfate dihydrate and sets to form the gypsum board,

wherein the polymer coating penetrates the outer surface of the face paper sheet a depth of 0 to 20% of thickness of the face paper sheet,

wherein a foamed gypsum core layer resulting from the set foamed gypsum slurry has a thickness of 0.25 to 1 inches and a density of 15 to 55 pounds/cubic foot, wherein the foamed gypsum core layer has a total void volume of 30 to 90 volume percent.

The product and method of the invention preferably applies to the face paper sheet 1.5 to 5 pounds per thousand square feet (MS F) of the polymer coating on a dry (water free) basis, more preferably 3 to 4 pounds/MSF, most preferably 3.1 to 3.7 pounds/MSF. Likewise, if the product and method of the invention applies the polymer coating composition to the backing paper sheet, then the invention applies to the backing paper 1.5 to 5 pounds per thousand square feet (MSF) of the polymer coating on a dry (water free) basis, more preferably 3 to 4 pounds/MSF, most preferably 3.1 to 3.7 pounds/MSF.

The invention seeks to minimize the air resistance of the coated paper to permit the paper to breathe so water in the gypsum slurry can escape through the coated paper when the gypsum slurry is being dewatered and dried to set the slurry to make wallboard. Air resistance of the coated paper was measured in a according to the test method TAPPI T460 OM-88, Air Resistance of Paper (Gurley Method) standard by Technical Association of the Pulp and Paper Industry (1988). This determines resistance to air permeability as the time in which a given air volume flows through paper when the air was forced to flow with a controlled pressure through a given area. Thus, the porosity of the board is less than 150 seconds according to TAPPI OM-88 test method, preferably 140 seconds or less according to the TAPPI OM-88 test method, more preferably 130 seconds or less according to the TAPPI OM-88 test method.

To facilitate manufacture the invention also seeks to make a coating with a kinematic viscosity that facilitates application of the coating. Thus, generally the kinematic viscosity of the coating composition is 55 to 70 ku. Preferably this kinematic viscosity is between 60 and 67 Krebs units (ku), more preferably between 61 and 63 ku.

The face paper sheet may be pre-coated, in other words, provided to the production line as a roll of sheet material coated with the polymer coating. In the alternative, the polymer coating may be applied to the outer side of the face paper sheet on the gypsum panel production line prior to deposition the layer of foamed gypsum. Thus, it may be applied after the foamed gypsum slurry sets. In another alternative, the polymer coating may be applied after the board sets. In all of these cases the polymer coating is typically applied to the face paper by a rod coater, curtain coater, sprayers, such as nozzles or shower sprayers, drip lines, and atomization techniques. Preferably the polymer coating is applied by rod coater to the face paper sheet.

If desired the outer surface of the backing paper may also be pre-coated with the polymer coating or coated with the polymer coating during or after board manufacture. In all of these cases the polymer coating is typically applied to the backing paper by a rod coater, curtain coater, sprayers, such as nozzles or shower sprayers, drip lines, and atomization techniques. Preferably the polymer coating is applied by rod coater to the backing paper sheet.

Preferably, the method of the invention further comprises:

depositing a first layer of relatively dense gypsum slurry comprising water and calcium sulfate hemihydrate directly on the inner bond surface of the face paper sheet to form a first layer of relatively dense slurry, and then the foamed gypsum slurry layer is applied on the first layer of relatively dense gypsum slurry;

wherein calcium sulfate hemihydrate in the relatively dense gypsum slurry converts to calcium sulfate dihydrate, the relatively dense gypsum slurry sets during formation of the gypsum board,

the first relatively dense gypsum slurry having a density greater than that of the foamed gypsum slurry, the first layer of relatively dense gypsum slurry being thinner than the foamed gypsum core layer, wherein the set first layer of relatively dense gypsum resulting from setting the relatively dense gypsum slurry has a total void volume of less than 30 volume percent.

Preferably, the method of the invention further comprises:

depositing a second layer of relatively dense gypsum slurry comprising water and calcium sulfate hemihydrate to form a second layer of relatively dense slurry on the inner bond surface of the backing paper sheet, and then contacting the foamed gypsum slurry layer and the second layer of relatively dense gypsum slurry to locate the second layer of relatively dense gypsum slurry between the backing paper and the foamed gypsum core;

wherein calcium sulfate hemihydrate in the second relatively dense gypsum slurry converts to calcium sulfate dihydrate, the second relatively dense gypsum slurry sets during formation of the gypsum board,

the second relatively dense gypsum slurry having a density greater than that of the foamed gypsum slurry, the second layer of relatively dense gypsum slurry being thinner than the foamed gypsum core layer, wherein the set second layer of relatively dense gypsum resulting from setting the second relatively dense gypsum slurry has a total void volume of less than 30 volume percent.

FIG. 4 shows a portion of the board of FIG. 3. FIG. 4 labels face paper thickness “F”. FIG. 4 also labels thickness “G” of the optional first relatively dense gypsum layer 8. The polymer of the polymer coating 6 migrate from the outer surface 5 of the face paper sheet 4 into the face paper sheet 4 at most a depth “F1” which is 0 to 20% of the thickness “F”.

The slurry from which the gypsum core material was made was a mixture of water and calcium sulfate hemihydrate at a water to calcium sulfate hemihydrate weight ratio of 0.2-1.5:1, preferably 0.2-0.8:1, more preferably 0.4-0.7:1. The board comprises the gypsum core sandwiched between the face paper sheet and a back paper sheet.

The core slurry preferably sets at least 50% in 10 minutes. Thus, the board is at least 50% set in 10 minutes.

The foam slurry of the invention for the gypsum core further comprises aqueous foam of air bubbles. Such composition and method provide a board of lighter weight, because the bubbles of aqueous foam result in corresponding air voids in the set gypsum core of the resultant board.

The foamed gypsum slurry has 15 to 70 volume percent air bubbles, more preferably 20 to 70 volume percent air, most preferably 20 to 60 volume percent air. The volume percent of total void volume of the gypsum board may be higher than the volume percent of bubbles of the foamed gypsum slurry from which the gypsum board is made. This is because additional voids (water voids) result from spaces between particles when water is removed as the slurry sets to form the board. Thus, the gypsum board may have a total void volume of 30 to 90 volume percent, more preferably 35 to 85 volume percent, most preferably 45 to 80 volume percent. If air is added in the method of the invention the calcium sulfate hemihydrate and water are mixed to form the slurry and then the air is added by entraining air into the slurry and/or by adding foam water to the slurry.

The relatively dense gypsum slurry has less than 30 volume % air, preferably less than 10 volume % air. The relatively dense gypsum layer resulting from the setting of the relatively dense gypsum slurry has total void volume less than 30 volume %, preferably less than 10 volume %.

The slurry comprises dispersant and a hydraulic component comprising at least 50% calcium sulfate hemihydrate by weight, preferably at least 80% calcium sulfate hemihydrate by weight, based on the dry weight of the hydraulic component and the slurry is made into a gypsum core material of a gypsum board (also known as a gypsum panel). The gypsum slurry from which the foamed gypsum layer and optional relatively dense gypsum layer was made has a water to calcium sulfate hemihydrate weight ratio of 0.1-1.5:1, preferably 0.2-0.8:1, more preferably 0.4-0.8:1.

The slurry is made from gypsum (calcium sulfate hemihydrate), water and the dispersant. In operation, to make the slurry for the board the gypsum is moved on a conveyor toward a slurry mixer. Prior to entry into the mixer, dry additives, such as dry set accelerators, are added to the powdered gypsum. Water is also added. Air is also added. Some additives are added directly to the mixer via a separate line. Other additives may also be added to the water.

The dispersant is preferably added to the water prior to addition of the stucco (as used in this specification stucco is the calcium sulfate hemihydrate). Gauge water or make-up water is added at the slurry mixer in amounts needed to meet the target water to stucco ratio when water from other sources has been considered. After contact with water the gypsum (calcium sulfate hemihydrate) converts to calcium sulfate dihydrate during production of the board.

The slurry from the slurry mixer for the gypsum core slurry then passes from the slurry mixer to a slurry distributor which deposits the slurry for the gypsum core slurry on the cover sheet on a forming table. If the cover sheet on the forming table also has the optional relatively denser gypsum layer then the gypsum core slurry is deposited on the relatively denser gypsum layer. Then after the gypsum core slurry is deposited a backing sheet is applied. If the backing sheet on also has the optional second relatively denser gypsum layer then the gypsum core slurry contacts the second relatively denser gypsum layer.

The paper backing sheet, which optionally has an outer polymer layer of the same polymer as on the face paper sheet, is directly contacted with the gypsum core layer or contacted with the second relatively denser gypsum slurry layer (if employed).

If desired a roll of pre-coated face paper may be employed in the production apparatus to make the board 10 of the invention. In the alternative the production apparatus also coats the face paper sheet to apply the coating during production of the board.

Likewise, if desired a roll of pre-coated backing paper may be employed in the production apparatus to make the board 10 of the invention. In the alternative the production apparatus also coats the backing paper sheet to apply the coating during production of the board (before contacting the gypsum or after the board sets).

A. Embodiments Employing Pre-Coated Face Paper Sheets

By employing pre-coated face paper sheets the board 2 can be made by known apparatus and methods for making gypsum board.

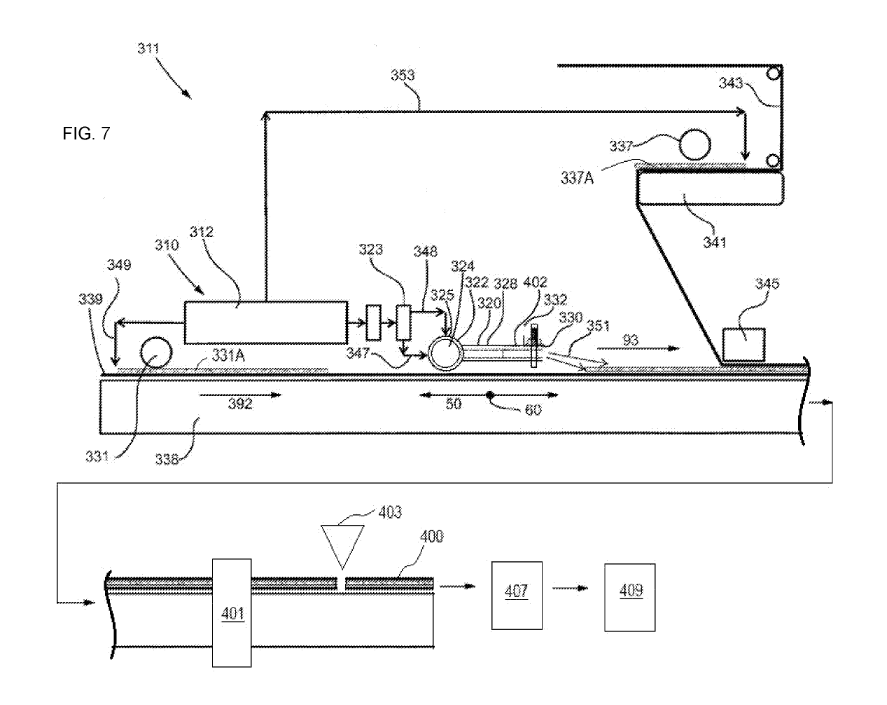

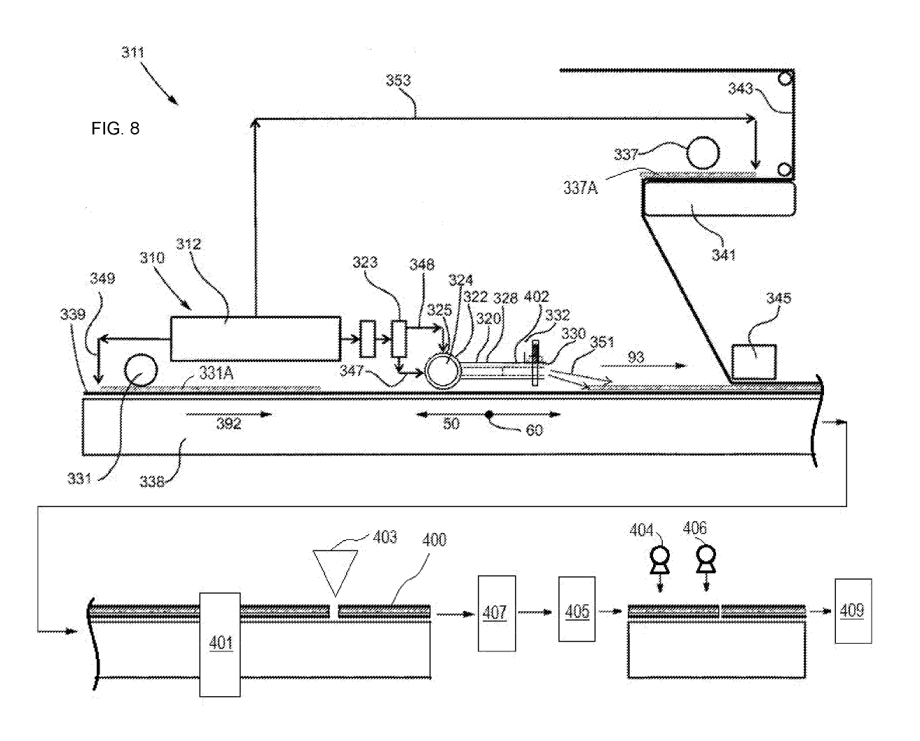

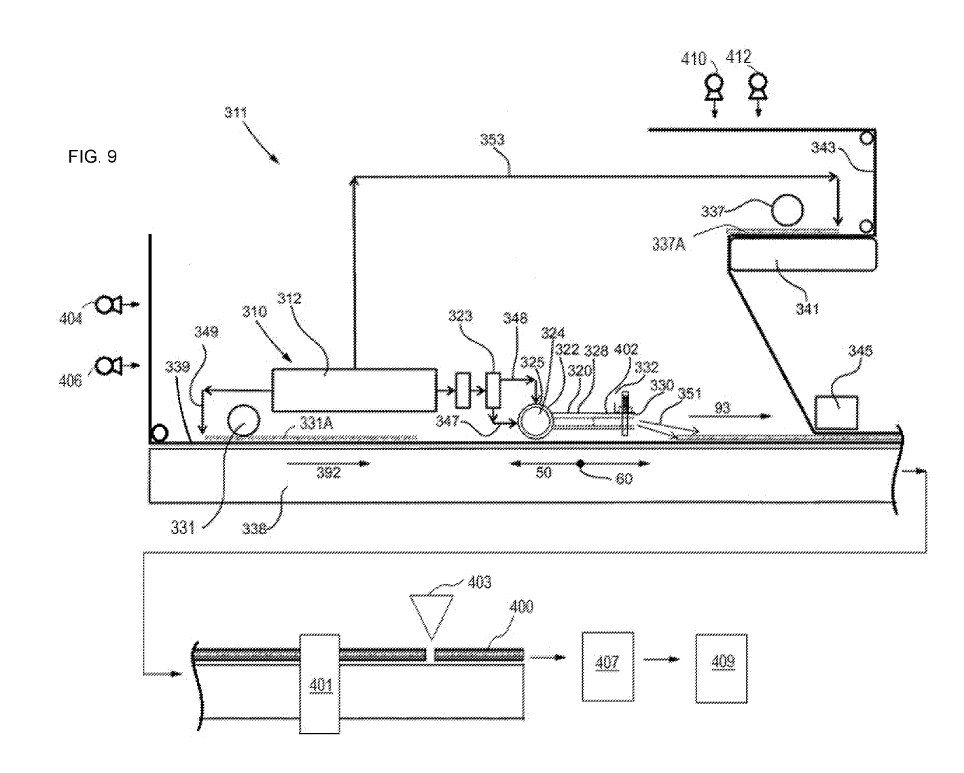

FIG. 7 shows one version of an apparatus for performing the method of the present invention to make a product of the present invention. This version includes apparatus for providing a face paper and backing paper as well as a first dense slurry layer 8 and a second dense slurry layer 14. However, first layer 8 of relatively dense gypsum and/or second layer 14 of relatively dense gypsum are optional in the apparatus and method of FIG. 7 as well as the apparatus and method of present FIGS. 8 and 9.

To provide the webs of cover sheet material for face paper sheet 4 and backing paper sheet 12 with the optional layers 8, 14 of relatively dense gypsum they are pre-treated with a very thin relatively denser layer of gypsum slurry (relative to the gypsum slurry comprising the core), often referred to as a skim coat in the art, and optionally hard edges as is known in the art.

The layers 8, 14 of relatively dense gypsum (if provided) each have a thickness of about 1 to 10% of the total thickness of the gypsum core (total of layers 8, 10 of FIG. 2 or layers 8, 10 and 14 of FIG. 3).

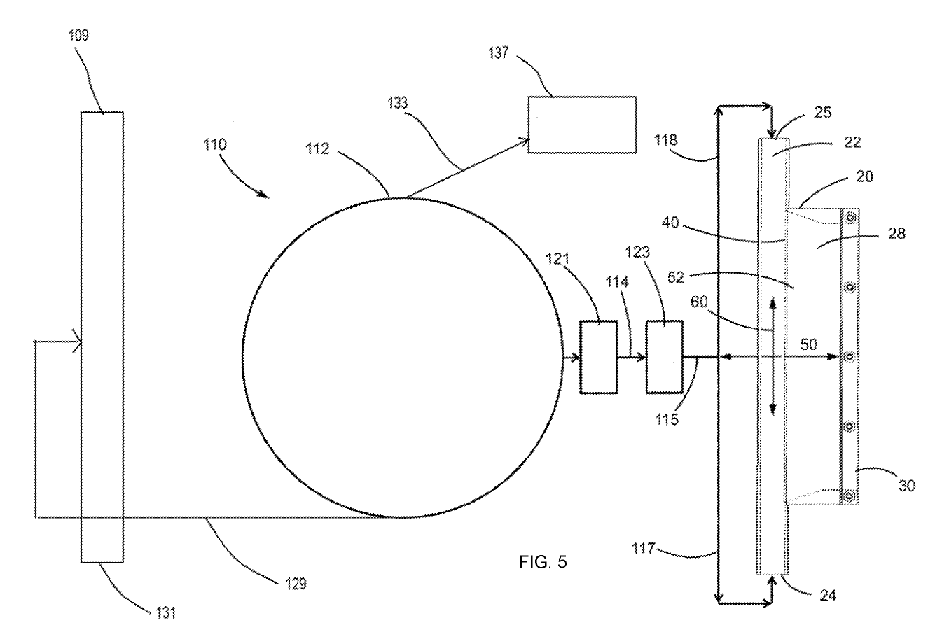

FIG. 5 shows an example of a gypsum slurry mixing and dispensing assembly 110 including a gypsum slurry mixer 112 in fluid communication with a slurry distributor 20. The gypsum slurry mixer 112 is adapted to agitate water and calcined gypsum to form aqueous calcined gypsum slurry. Both the water and the calcined gypsum can be supplied to the mixer 112 via one or more inlets as is known in the art. Any suitable mixer can be used with the slurry distributor.

This assembly 110 would deposit the gypsum core slurry on at least one moving web of paper cover sheet (see FIG. 7) pre-coated with a polymer layer positioned to face away from the gypsum core slurry. As explained below assembly 110 also provides apparatus to apply an optional relatively denser layer of gypsum slurry (denser than the gypsum core slurry) between the paper cover sheet and the gypsum core slurry layer.

The slurry distributor 20 includes a first feed inlet 24 adapted to receive a first flow of aqueous calcined gypsum slurry from the gypsum slurry mixer 112, a second feed inlet 25 adapted to receive a second flow of aqueous calcined gypsum slurry from the gypsum slurry mixer 112, and a distribution outlet 30 in fluid communication with both the first and the second feed inlets 24, 25 and adapted to discharge the first and second flows of aqueous calcined gypsum slurry the slurry distributor 20 through the distribution outlet 30.

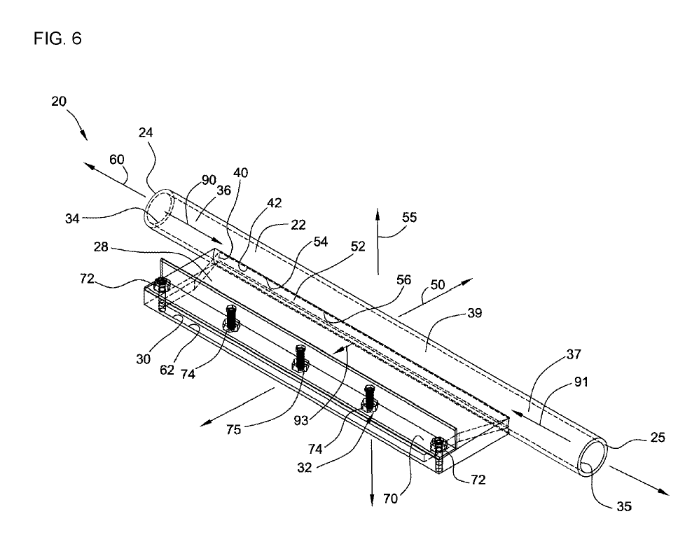

The slurry distributor 20 also includes a feed conduit 22 in fluid communication with a distribution conduit 28. The feed conduit extends generally along a transverse axis 60 and includes the first feed inlet 24, the second feed inlet 25 disposed in spaced relationship to the first feed inlet 24, and a feed outlet 40 in fluid communication with the first feed inlet 24 and the second feed inlet 25. The distribution conduit 28 extends generally along a longitudinal axis 50, which is substantially perpendicular to the longitudinal axis 60, and includes an entry portion 52 and the distribution outlet 30. The entry portion 52 is in fluid communication with the feed outlet 40 of the feed conduit 22 such that the entry portion 52 is adapted to receive both the first and the second flows of aqueous calcined gypsum slurry from the feed outlet 40 of the feed conduit 22. The distribution outlet 30 is in fluid communication with the entry portion 52. The distribution outlet 30 of the distribution conduit 28 extends a predetermined distance along the transverse axis 60. The slurry distributor 20 is shown in more detail by FIG. 6.

FIG. 5 shows a delivery conduit 114 is disposed between and in fluid communication with the gypsum slurry mixer 112 and the slurry distributor 20. The delivery conduit 114 includes a main delivery trunk 115, a first delivery branch 117 in fluid communication with the first feed inlet 24 of the slurry distributor 20, and a second delivery branch 118 in fluid communication with the second feed inlet 25 of the slurry distributor 20. The main delivery trunk 115 is in fluid communication with both the first and second delivery branches 117, 118. In other embodiments, the first and second delivery branches 117, 118 can be in independent fluid communication with the gypsum slurry mixer 112.

The delivery conduit 114 can be made from any suitable material and can have different shapes. In some embodiments, the delivery conduit can comprise a flexible conduit.

An aqueous foam supply conduit 121 can be in fluid communication with at least one of the gypsum slurry mixer 112 and the delivery conduit 114. Aqueous foam from a source can be added to the constituent materials through the foam supply conduit 121 at any suitable location downstream of the mixer 112 and/or in the mixer 112 itself to form foamed gypsum slurry that is then provided to the slurry distributor 120. In the illustrated embodiment, the foam supply conduit 121 is disposed downstream of the gypsum slurry mixer 112. In the illustrated embodiment, the aqueous foam supply conduit 121 has a manifold-type arrangement for supplying foam to an injection ring or block associated with the delivery conduit 114 as described in U.S. Pat. No. 6,874,930, for example.

In other embodiments, one or more secondary foam supply conduits can be provided in fluid communication with the mixer. In yet other embodiments, the aqueous foam supply conduit(s) can be in fluid communication with the gypsum slurry mixer alone.

In yet other embodiments, first and second delivery branches can each include a foam supply conduit therein respectively adapted to independently introduce aqueous foam into the first and second flows of aqueous calcined gypsum slurry delivered to the slurry distributor. In still other embodiments, a plurality of mixers can be provided to provide independent streams of slurry to the first and second feed inlets of a slurry distributor constructed in accordance with principles of the present disclosure.

When the foamed gypsum slurry sets and is dried, the foam dispersed in the slurry produces air voids therein which act to lower the overall density of the wallboard. The amount of foam and/or amount of air in the foam can be varied to adjust the dry board density such that the resulting wallboard product is within a desired weight range.

Any suitable foaming agent can be used. Preferably, the aqueous foam is produced in a continuous manner in which a stream of the mix of foaming agent and water is directed to a foam generator, and a stream of the resultant aqueous foam leaves the generator and is directed to and mixed with the calcined gypsum slurry. Some examples of suitable foaming agents are described in U.S. Pat. Nos. 5,683,635 and 5,643,510, for example.

One or more flow-modifying elements 123 can be associated with the delivery conduit 114 to control the first and the second flows of aqueous calcined gypsum slurry from the gypsum slurry mixer 112. In the illustrated embodiment of FIG. 6, the flow-modifying element(s) 123 is associated with the main delivery trunk 115. Examples of suitable flow-modifying elements include volume restrictors, pressure reducers, constrictor valves, canisters etc.

Optionally at least one the webs of cover sheet material having the polymer layer is also treated to apply over the bond side a very thin relatively denser layer of gypsum slurry (relative to the gypsum slurry comprising the core), often referred to as a skim coat in the art over the field of the web and at least one denser stream of gypsum slurry at the edges of the web. The very thin relatively denser layer of gypsum slurry is applied directly to the bond side.

To that end, the mixer 112 optionally includes a first auxiliary conduit 129 adapted to deposit a stream of dense aqueous calcined gypsum slurry relatively denser than the first and second flows of aqueous calcined gypsum slurry delivered to the slurry distributor (i.e., a “face skim coat/hard edge stream”). The first auxiliary conduit 129 can deposit the face skim coat and hard edge stream upon a moving web of cover sheet material upstream of a skim coat roller 131 adapted to apply a skim coat layer to the moving web of cover sheet material and to define hard edges at the periphery of the moving web by virtue of the width of the roller 131 being less than the width of the moving web as is known in the art. Hard edges can be formed from the same dense slurry that forms the thin dense layer by directing portions of the dense slurry around the ends of the roller used to apply the dense layer to the web.

The mixer 112 can also optionally include a second auxiliary conduit 133 adapted to deposit a stream of dense aqueous calcined gypsum slurry that is relatively denser than the first and second flows of aqueous calcined gypsum slurry delivered to the slurry distributor (i.e., a “back skim coat stream”). The second auxiliary conduit 133 can deposit the back skim coat stream upon a second moving web of cover sheet material upstream (in the direction of movement of the second web) of a skim coat roller 137 that is adapted to apply a skim coat layer to the second moving web of cover sheet material as is known in the art (see FIG. 7 also). At least one of the first moving web of cover sheet material and the second moving web of cover sheet material is precoated with the polymer before depositing the stream of dense aqueous calcined gypsum slurry.

In other embodiments, separate auxiliary conduits can be connected to the mixer to deliver one or more separate edge streams to the moving web of cover sheet material. Other suitable equipment (such as auxiliary mixers) can be provided in the auxiliary conduits to help make the slurry therein denser, such as by mechanically breaking up foam in the slurry and/or by chemically breaking down the foam through use of a suitable de-foaming agent.

FIG. 6 shows a perspective view of the gypsum slurry distributor 20 of FIG. 5. Other suitable slurry distributors are also known in the art. FIG. 6 shows the slurry distributor 20 adapted to locally vary the size and/or shape of the distribution outlet 30 of the distribution conduit 28.

The feed conduit 22 extends substantially along the transverse axis or cross-machine direction 60, which is substantially perpendicular to a longitudinal axis or machine direction 50. The first feed inlet 24 and the second feed inlet 25 define openings 34, 35 that have substantially the same area. The first and second feed inlets 24, 25 are in opposing relationship to each other along the transverse axis or cross-machine direction 60 with the cross-sectional planes defined by the openings 34, 35 being substantially perpendicular to the transverse axis 60.

The feed conduit 22 includes first and second entry segments 36, 37 and an intermediate connector segment 39. The first and second entry segments 36, 37 are generally cylindrical and extend along the transverse axis 60. The first and second feed inlets 24, 25 are disposed at the distal ends of the first and the second entry segments 36, 37, respectively, and are in fluid communication therewith.

The connector segment 39 is generally cylindrical and is in fluid communication with both the first and the second entry segments 36, 37. The connector segment 39 defines a feed outlet 40 in fluid communication with the first and second feed inlets 24, 25 and the distribution conduit 28. The feed outlet 40 is adapted to receive a first flow in a first feed direction 90 and a second flow in a second flow direction 91 of aqueous calcined gypsum slurry from the first and second feed inlets 24, 25, respectively, and to direct the first and second flows 90, 91 of aqueous calcined gypsum slurry into the distribution conduit 28. The feed outlet 40 is disposed intermediately between the first feed inlet 24 and the second feed inlet 25. The illustrated feed outlet 40 defines a generally rectangular opening 42 that follows the curvature of the illustrated substantially cylindrical feed conduit 22.

The distribution conduit 28 extends generally along the longitudinal axis 50 and includes an entry portion 52 and the distribution outlet 30. The entry portion 52 is in fluid communication with the feed outlet 40 of the feed conduit 22, and thus the first and the second feed inlets 24, 25, as well. The entry portion 52 is adapted to receive both the first and the second flows 90, 91 of aqueous calcined gypsum slurry from the feed outlet 40 of the feed conduit 22. The entry portion 52 of the distribution conduit 28 includes a distribution inlet 54 in fluid communication with the feed outlet 40 of the feed conduit 22. The illustrated distribution 54 inlet defines an opening 56 that substantially corresponds to the opening 42 of the feed outlet 40.

The distribution outlet 30 is in fluid communication with the entry portion 52 and thus the feed outlet 40 and both the first and second feed inlets 24, 25. The illustrated distribution outlet 30 defines a generally rectangular opening 62. The distribution outlet 30 has a width that extends a predetermined distance along the transverse axis 60 and a height that extends a predetermined distance along a vertical axis 55, which is mutually perpendicular to the longitudinal axis 50 and the transverse axis 60. The distribution outlet opening 62 has an area smaller than the area of the opening 56 of the distribution inlet 54, but greater than the sum of the areas of the openings 34, 35 of the first and second feed inlets 24, 25.

The slurry distributor is adapted such that the combined first and second flows 90, 91 of aqueous calcined gypsum slurry move through the entry portion 52 from the distribution inlet 54 generally along a distribution direction 93 toward the distribution outlet opening 62. The illustrated distribution direction 93 is substantially along the longitudinal axis 50.

A profiling system 32 includes a plate 70, a plurality of mounting bolts 72 securing the plate to the distribution conduit 28 adjacent the distribution outlet 30, and a series of adjustment bolts 74, 75 threadingly secured thereto. The mounting bolts 72 are used to secure the plate 70 to the distribution conduit 28 adjacent the distribution outlet 30. The plate 70 extends substantially along the transverse axis 60 over the width of the distribution outlet 30. The adjustment bolts 74, 75 are independently adjustable to locally vary the size and/or shape of the distribution outlet 30.

Referring again to FIG. 7, an exemplary embodiment of a gypsum wallboard manufacturing line 311 is shown. The line 311 includes a gypsum slurry mixing and dispensing assembly 310 including a slurry distributor 320 (such as slurry distributor 20 of FIG. 6), a hard edge/face skim coat roller 331 disposed upstream of the slurry distributor 320 and supported over a forming table 338 such that a first moving web 339 of cover sheet material is disposed there between, a back skim coat roller 337 disposed over a support element 341 such that a second moving web 343 of cover sheet material is disposed there between, and a forming station 345 adapted to shape the preform into a desired thickness. The skim coat rollers 331, 337, the forming table 338, the support element 341, and the forming station 345 can all comprise conventional equipment suitable for their intended purposes as is known in the art. The line 311 can be equipped with other conventional equipment as is known in the art.

Water and calcined gypsum can be mixed in the mixer 312 to form the first and second flows 347, 348 of aqueous calcined gypsum slurry. Generally, the water and calcined gypsum can be continuously added to the mixer in a water-to-calcined gypsum ratio such that the gypsum slurry from which the foamed gypsum layer and optional relatively dense gypsum layer was made has a water to calcium sulfate hemihydrate weight ratio of 0.1-1.5:1, preferably 0.2-0.8:1, more preferably 0.4-0.8:1.

The slurry distributor 320 distributes the aqueous calcined gypsum slurry upon the first advancing web 339.

Gypsum board products are typically formed “face down” such that the advancing web 339 serves as the “face” cover sheet of the finished board. A face skim coat/hard edge stream 349 (a layer of denser aqueous calcined gypsum slurry relative to at least one of the first and second flows of aqueous calcined gypsum slurry) can be applied as a face skim coat/hard edge 331A to the first moving web 339 upstream of the hard edge/face skim coat roller 331, relative to the machine direction 392, to apply a skim coat layer 331A to the first web 339 and to define hard edges of the board. At the time of applying the skim coat layer 331A, the “face” cover sheet already has the polymer coating on the side opposed to the side to which the skim coat layer is applied.

Foam conduit 321 is employed as explained for foam conduit 121 of FIG. 5 such that foamed slurry is fed to the slurry distributor 20.

The first flow 347 and the second flow 348 of aqueous calcined gypsum slurry are respectively passed through the first feed inlet 324 and the second feed inlet 325 of the slurry distributor 320. The first feed inlet 324 and the second feed inlet 325 are respectively disposed on opposing sides of the slurry distributor 320. The first and second flows 347, 348 of aqueous calcined gypsum slurry are combined in the slurry distributor 320. The first and second flows 347, 348 of aqueous calcined gypsum slurry move along a flow path through the slurry distributor 320 in the manner of a streamline flow, undergoing minimal or substantially no air-liquid slurry phase separation and substantially without undergoing a vortex flow path.

The first moving web 339 moves along the longitudinal axis 50. The first flow 347 of aqueous calcined gypsum slurry passes through the first feed inlet 324 moving in the first feed direction 90, and the second flow 348 of aqueous calcined gypsum slurry passes through the second feed inlet 325 moving in the second feed direction 91, which is in opposing relationship to the first feed direction 90. The first and the second feed direction 90, 91 are substantially parallel to the transverse axis 60, which is substantially perpendicular to the longitudinal axis 50 (see FIG. 5 also).

The distribution conduit 328 is positioned such that it extends along the longitudinal axis 50 which substantially coincides with the machine direction 392 along which the first web 339 of cover sheet material moves. Preferably, the central midpoint of the distribution outlet 330 (taken along the transverse axis/cross-machine direction) substantially coincides with the central midpoint of the first moving cover sheet 339. The first and second flows 347, 348 of aqueous calcined gypsum slurry combine in the slurry distributor 320 such that the combined first and second flows 351 of aqueous calcined gypsum slurry pass through the distribution outlet 330 in a distribution direction 93 generally along the longitudinal axis 50.

In some embodiments, the distribution conduit 328 is positioned substantially parallel to the plane defines by the longitudinal axis 50 and the transverse axis 60 of the first web 339 moving along the forming table. In other embodiments, the entry portion of the distribution conduit can be disposed vertically lower or higher than the distribution outlet 330 relative to the first web 339.

The combined first and second flows 351 of aqueous calcined gypsum slurry are discharged from the slurry distributor 320 upon the first moving web 339. The face skim coat/hard edge stream 349 (if employed) can be deposited from the mixer 312 at a point upstream, relative to the direction of movement of the first moving web 339 in the machine direction 392, of where the first and second flows 347, 348 of aqueous calcined gypsum slurry are discharged from the slurry distributor 320 upon the first moving web 339. The first and second flows 347, 348 of aqueous calcined gypsum slurry respectively passed through the first and second feed inlets 324, 325 of the slurry distributor 320 can be selectively controlled with at least one flow-modifying element 323.

The combined first and second flows 351 of aqueous calcined gypsum slurry are discharged from the slurry distributor 320 through a distribution outlet 330. The distribution outlet 330 has a width extending along the transverse axis 60 and sized such that the ratio of the width of the first moving web 339 of cover sheet material to the width of the distribution outlet 330 is within a range including and between about 1:1 and about 6:1.

The combined first and second flows 351 of aqueous calcined gypsum slurry discharging from the slurry distributor 320 form a spread pattern upon the moving web 339. At least one of the size and shape of the distribution outlet 330 can be adjusted, which in turn can change the spread pattern.

Thus, slurry is fed into both feed inlets 324, 325 of the feed conduit 322 and then exits through the distribution outlet 330 with an adjustable gap. The converging portion 402 can provide a slight increase in the slurry velocity to reduce unwanted exit effects and improve flow stability at the free surface. Side-to-side flow variation and/or any local variations can be reduced by performing cross-machine (CD) profiling control at the discharge outlet 330 using the profiling system 332.

A back skim coat stream 353 (for the optional layer of denser aqueous calcined gypsum slurry relative to at least one of the first and second flows 347, 348 of aqueous calcined gypsum slurry) can be applied to the second moving web 343. The back skim coat stream 353 (if employed) can be deposited as a back skim coat 337A from the mixer 312 at a point upstream, relative to the direction of movement of the second moving web 343, of the back skim coat roller 337. If the second moving web has been precoated with the polymer layer, then at the time of applying the skim coat layer 337A, the second moving web already has the polymer coating on the side opposed to the side to which the skim coat layer 337A is applied.

Thus, to make wallboard panels the foamed core slurry including calcium sulfate hemihydrate and water used to form the core, and the thin denser slurry including calcium sulfate hemihydrate and water used to form the skim layer 331A, are continuously deposited on the first paper cover sheet moving beneath a mixer. A second paper cover sheet optionally having its own skim layer 337A including calcium sulfate hemihydrate and water is then applied there over and the resultant assembly is formed into a continuous strip having the shape of a panel. Calcium sulfate hemihydrate reacts with a sufficient amount of the water to convert the hemihydrate into a matrix of interlocking calcium sulfate dihydrate crystals, causing it to set and to become firm. The continuous strip thus formed is conveyed on the belt until the calcined gypsum is dewatered in a dewatering station 401 and then set, and the strip is thereafter cut at a cutting station 403 to form boards 400 of desired length, which boards are conveyed through a drying kiln 407 to remove excess moisture and then sent to storage 409.

In the apparatus of FIG. 7 the precoated face paper is oriented to have the polymer coating on the side facing away from the gypsum core slurry.

In the apparatus of FIG. 7 the backing paper, if pre-coated with polymer coating, is oriented to have the polymer coating on the side facing away from the gypsum core slurry.

B. Processes and Apparatus Applying Polymer for Coating after Board Manufacture

Rather than employing precoated face paper sheets and backing paper sheets, the face paper sheets and backing paper sheets may be coated after board manufacture. As in the case of using polymer precoated paper sheets, when applied after board manufacture the polymer of the polymer coating will be disposed on the entire outer surface of the face paper sheet.

As shown by FIG. 8, the boards are made by the apparatus and method of FIG. 7 except the face paper 339 and back paper 343 are not precoated. Then after board manufacture the boards are flipped upside down by a flipping step 405. The flipping step may be done manually or by any suitable device that can flip a gypsum board. Then the boards are put on a conveyor belt and the coating is applied by a spray nozzle 404 for spraying polymer coating onto the first moving web 339. If desired the production line is also provided with a dryer 406 to dry the polymer coating. Sprayer 404 may be replaced by other suitable coating devices. Then the boards are sent to storage 409. If it is desired to also coat the outer surface of the second moving web 343 then another sprayer and optionally followed by another dryer (neither of which are shown) may be provided to coat the outer surface of the back paper 343 between the step of drying in the dryer 407 and the flipping step 405. The coatings can be applied using traditional coating machinery, such as, a rod coater, curtain coater, sprayers, such as nozzles or shower sprayers (as shown in FIG. 8), drip lines, and atomization techniques. Preferably the polymer coating is applied by rod coater to the face paper sheet. The polymer coating is applied as an aqueous latex dispersion. The driers 406, 412 can be any suitable driers. For example air driers or heat lamps producing infrared light.

In the apparatus of FIG. 8, the sprayer 404 and dryer 406 are oriented to coat the polymer coating on the outer side of the face paper facing away from the gypsum core slurry. In the apparatus of FIG. 8, the sprayer 410 and dryer 412 were oriented to have the polymer coating on the side of the backing paper facing away from the gypsum core slurry.

C. Processes and Apparatus Applying Polymer for Coating During Board Manufacture

In another alternative the face paper sheets and backing paper sheets may be coated during board manufacture. As in the case of using polymer precoated paper sheets, when applied during board manufacture the polymer of the polymer coating will be disposed on the entire outer surface of the face paper sheet.

FIG. 9 shows the production line of FIG. 7 modified to coat the polymer onto the first moving web 339 for face paper sheets and the second moving web 343 for backing paper sheets. In particular, the production line of FIG. 9 provides a spray nozzle 404 for spraying polymer coating onto the first moving web 339. If desired the production line is also provided with a dryer 406 to dry the polymer coating. The production line of FIG. 9 also provides a spray nozzle 410 for spraying polymer coating onto the second moving web 353. If desired the production line is also provided with a dryer 412 to dry the polymer coating. The coating can be applied using traditional coating machinery, such as a rod coater, curtain coater, sprayers (as shown in FIG. 9), such as nozzles or shower sprayers, drip lines, and atomization techniques. Preferably the polymer coating is applied by rod coater to the face paper sheet. The driers 406, 412 can be any suitable driers. For example air driers or heat lamps producing infrared light.

The polymer coating is applied as an aqueous latex dispersion.

In the apparatus of FIG. 9, the sprayer 404 and dryer 406 were oriented to coat the polymer coating on the side of the face paper facing away from the gypsum core slurry.

In the apparatus of FIG. 9, the sprayer 410 and dryer 412 were oriented to have the polymer coating on the side of the backing paper facing away from the gypsum core slurry.

Polymer for Coating

The coating composition used in the present invention comprises a polymer as a binder. In particular the polymer is a synthetic latex (i.e., an aqueous dispersion of polymer particles prepared by emulsion polymerization of one or more monomers). The polymer of the polymer coating is disposed on the entire outer surface of the face paper sheet to face away from the gypsum core. A portion of the polymer coating may penetrate from the inner surface of the face paper sheet through a portion of the face paper sheet 0 to 20% of the thickness of the sheet. However, the polymer coating does not penetrate into the gypsum core. Nor does it penetrate into the thin denser gypsum layer between the coating and the foamed gypsum core. The latex polymer coating composition comprises an aqueous emulsion or dispersion comprising water, the polymer, surfactant, and other ingredients as described elsewhere in the present specification.

The latex polymer has a glass transition temperature (Tg) of 0 to 35° F., preferably 25 to 32° F. Also, the latex polymer has a weight average molecular weight of 40,000 to 500,000.

The latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex.

Generally the polymer is applied in an amount equal to that to form a polymer coating having a thickness of 30 mils or less. This depth does not include the depth (if any) to which the polymer penetrates the paper sheet.

Methods for preparing synthetic latexes are well known in the art and any of these procedures can be used.

Particle size of the latex can vary from 30 nm to 1500 nm.

Dispersant for the Latex Polymer Coating Composition

The latex polymer coating composition contains 0 to 0.5 wt. % dispersant selected from at least one member of the group consisting of polycarboxylate dispersant, polyphosphate dispersant, and naphthalene dispersant.

The dispersants for the latex are typically nonionic or anionic surface-active compounds (surfactants or emulsifiers) or mixtures thereof. Anionic surfactants contain anionic functional groups at their head, such as sulfate, sulfonate, phosphate, and carboxylates. Representative anionic emulsifiers include the alkyl aryl sulfonates, alkali metal alkyl sulfates, the sulfonated alkyl esters, and fatty acid soaps. Specific examples include sodium dodecylbenzene sulfonate, sodium butylnaphthalene sulfonate, betanaphthalene formaldehyde condensate, sodium lauryl sulfate, disodium dodecyl diphenyl ether disulfonate, N-octadecyl sulfosuccinate and dioctyl sodiumsulfosuccinate.

Polycarboxlate dispersants are a preferred type of dispersants. More preferred are polycarboxylic ether dispersants. Most preferably the polycarboxylate dispersant comprises a copolymer of an oxyalkylene-alkyl ether and an unsaturated dicarboxylic acid.

U.S. Pat. No. 7,767,019 to Liu et al, incorporated herein by reference, discloses embodiments of branched polycarboxylates suitable as dispersants for use with the present polymer coatings. These are also anionic surfactants. Liu et al discloses polycarboxylate dispersant consisting essentially of a first and a second repeating unit, wherein the first repeating unit is an olefinic unsaturated mono-carboxylic acid repeating unit or an ester or salt thereof, or an olefinic unsaturated sulphuric acid repeating unit or a salt thereof, and the second repeating unit is of the general formula (I)

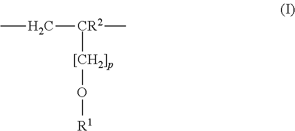

where R¹ is represented by formula (II):

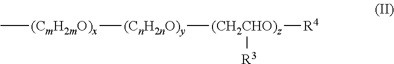

and wherein R² is hydrogen or an aliphatic C₁ to C₅ hydrocarbon group, R³ is a non-substituted or substituted aryl group, and R⁴ is hydrogen or an aliphatic C₁ to C₂₀ hydrocarbon group, a cycloaliphatic C₅ to C₈ hydrocarbon group, a substituted C₆ to C₁₄ aryl group or a group conforming to one of the formulae (III):

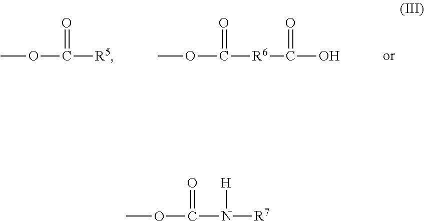

wherein R₅ and R₇, independently of each other, represent an alkyl, aryl, aralkyl or alkylaryl group and R₆ is a divalent alkyl, aryl, aralkyl or alkaryl group, p is 0 to 3, inclusive, m and n are, independently, an integer from 2 to 4, inclusive; x and y are, independently, integers from 55 to 350, inclusive and z is from 0 to 200, inclusive.

Preferably the naphthalene dispersant is selected from at least one of beta-naphthalene sulfonate, naphthalene sulfonate formaldehyde condensate and sodium naphthalene sulfate formaldehyde condensate.

Preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP).

Suitable nonionic emulsifiers include polyoxyethylene condensates. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic emulsifying agents that can be used also include a series of surface active agents available from BASF under the PLURONIC and TETRONIC trade names. In addition, a series of ethylene oxide adducts of acetylenic glycols, sold commercially by Air Products under the SURFYNOL trade name, are suitable as nonionic emulsifiers.

In addition, suitable amino alcohols, such as, for example, 2-amino-2-methylpropanol, may be used as dispersants.

Dispersant for the Gypsum Slurries

Dispersants are known for use with gypsum in gypsum slurries to help fluidize the mixture of water and calcium sulfate hemihydrate so less water is needed to make flowable slurry.

The gypsum slurries typically contain a dispersant such as polynaphthalene sulfonate. Polynaphthalene sulfonate dispersants are well known and relatively cheaper, but have limited efficacy. Polynaphthalene sulfonate has good compatibility with starch, foaming agents, and clays. A production process for polynaphthalene sulfonates includes the following reaction steps: sulfonation of naphthalene with sulfuric acid producing b-naphthalene-sulfonic acid, condensation of b-naphthalene sulfonic acid with formaldehyde producing polymethylene naphthalene sulfonic acid, and neutralization of polymethylene naphthalene sulfonic acid with sodium hydroxide or another hydroxide.

Polycarboxylate dispersants are also suitable dispersants for gypsum slurries. Preferred polycarboxylate dispersants for gypsum slurries comprise a polycarboxylic ether dispersant, for example dispersant comprising a copolymer of an oxyalkylene-alkyl ether and an unsaturated dicarboxylic acid.

U.S. Pat. No. 7,767,019 to Liu et al, incorporated by reference, discloses embodiments of branched polycarboxylates suitable for use as dispersants for the present gypsum slurries.

U.S. Pat. No. 8,142,915 to Blackburn et al, incorporated by reference, also discloses embodiments of polycarboxylates suitable for use as dispersants for the present gypsum slurries.

Enhancing Materials for Gypsum Slurries Chosen from Condensed Phosphoric Acids

Preferably the foamed gypsum slurry also contains enhancing materials chosen from condensed phosphoric acids, each of which comprises 2 or more phosphoric acid units; and salts or ions of condensed phosphates, each of which comprises 2 or more phosphate units. The enhancing materials are preferably chosen from the group consisting of: phosphoric acids, each of which comprises 1 or more phosphoric acid units; salts or ions of condensed phosphates, each of which comprises 2 or more phosphate units; and monobasic salts or monovalent ions of orthophosphates. The enhancing materials will impart increased resistance to permanent deformation to the set gypsum formed. Moreover, some enhancing materials (e.g., the following salts, or the anionic portions thereof: sodium trimetaphosphate (also referred to herein as STMP), sodium hexametaphosphate having 6-27 repeating phosphate units (also referred to herein as SHMP), and ammonium polyphosphate having 1000-3000 repeating phosphate units (also referred to herein as APP) will provide preferred benefits, such as greater increase in sag resistance. Also, APP provides equal sag resistance to that provided by STMP, even when added in only one fourth the STMP concentration.

Typically, this is accomplished by adding trimetaphosphate ion to a mixture of calcined gypsum and water to be used to produce set gypsum-containing products.

Calcined Gypsum

As used herein, the term, “calcined gypsum”, is intended to mean alpha calcium sulfate hemihydrate, beta calcium sulfate hemihydrate, water-soluble calcium sulfate anhydrite, or mixtures of any or all thereof, and the terms, “set gypsum” and “hydrated gypsum”, are intended to mean calcium sulfate dihydrate. The water in the mixture reacts spontaneously with the calcined gypsum to form set gypsum.

The calcined gypsum employed in the invention can be in the form and concentrations typically found useful in the corresponding embodiments of the prior art It can be alpha calcium sulfate hemihydrate, beta calcium sulfate hemihydrate, water-soluble calcium sulfate anhydrite, or mixtures of any or all thereof, from natural or synthetic sources. In some preferred embodiments alpha calcium sulfate hemihydrate is employed for its yield of set gypsum having relatively high strength. If desired beta calcium sulfate hemihydrate or a mixture of beta calcium sulfate hemihydrate and water-soluble calcium sulfate anhydrite are employed.

Water

Water is added to the slurry in any amount that makes a flowable slurry. The amount of water to be used varies greatly according to the application with which it is being used, the exact dispersant being used, the properties of the stucco and the additives being used. The water to stucco weight ratio (“WSR”) with wallboard is 0.1-1.5:1, preferably 0.2-0.8:1, more preferably 0.4-0.8:1.

Water used to make the slurry should be as pure as practical for best control of the properties of both the slurry and the set plaster. Salts and organic compounds are well known to modify the set time of the slurry, varying widely from accelerators to set inhibitors. Some impurities lead to irregularities in the structure as the interlocking matrix of dihydrate crystals forms, reducing the strength of the set product. Product strength and consistency is thus enhanced by the use of water that is as contaminant-free as practical.

Additives for Polymer Coatings

Additives which can be employed in the polymer coatings in the practice of the invention to impart desirable properties and to facilitate manufacturing are selected from one or more members of the group silicon based defoamers, acrylate thickeners, cellulose thickeners, inorganic filler powder, pH adjuster, preferably alkanolamines, and pigments as well as the abovementioned dispersant.

The compositions of the invention comprise clay and/or an inorganic filler powder selected from at least one member of the group consisting of calcium carbonate and calcium sulfate dihydrate. The compositions of the invention preferably include calcined clay and an inorganic filler powder selected from at least one member of the group consisting of calcium carbonate and calcium sulfate dihydrate. More preferably the compositions of the invention include a mixture of calcined clay and ground calcium carbonate (which is coarser than calcined clay) or a mixture of calcined clay and ground landplaster (which is coarser than calcined clay).

However, compositions of the invention may employ calcium carbonate alone with an absence of clay and an absence of calcium sulfate dihydrate.

The clay has an average particle size of 0.3 to 3.7 microns. Preferably the clay is calcined clay having average particle size of 2.8 to 3.5 microns. If the particle size is smaller than 0.1 micron then the powder will be too fine and block the paper pores to prevent moisture evaporation during the board drying process. If the particle size is bigger than 4.0 microns, the produced boards would be too dusty and make handling and further painting difficult.

The clay is used in amounts ranging from 0 to 17 wt. %, preferably 8 to 17 wt. %, more preferably 9.5 to 11 wt. %, clay, based on the total weight of the polymer coating composition (on a water included basis). The clays are preferably calcined. The term “calcined clays” according to the present invention is to be understood as clays having been submitted to a thermal treatment, e.g., heated, to drive off volatile compounds. Representative clays include, but are not limited to montmorillonite, nontronite, beidellite, volkonskoite, hectorite, saponite, sauconite; vermiculite; halloisite; sericite; or their mixtures.

There is 20 to 45 wt. %, preferably 20 to 31 wt. %, more preferably 25 to 31 wt. %, inorganic filler powder based on the total weight of the polymer coating composition (on a water included basis). The inorganic filler powder is selected from at least one member of the group consisting of calcium carbonate and calcium sulfate dihydrate. The total of the clay and inorganic filler is 28 to 48%, preferably 34.5 to 42%, based on the total weight of the applied coating composition (on a water included basis).

Calcium carbonate is a chemical compound with the formula CaCO₃. The calcium carbonate particles are generally spherical in shape. Typically, the CaCO₃ has a purity of at least 90 wt. %, more typically at least 95 wt. % and even more typically at least 98 wt. %. The calcium carbonate has an average particle size of 0.7 to 1.2 microns, preferably 0.8 to 1.0 microns.

The calcium sulfate dihydrate is typically in the form of ground landplaster. The calcium sulfate dihydrate has an average particle size of 0.7 to 10 microns, preferably 2.5 to 4 microns.

The coating composition applied to the face paper and backing paper has 0.02 to 0.5 wt. % thickener. Preferably the thickener is selected from at least one member of the group consisting of a cellulose thickener and an acrylate thickener. Preferred cellulose thickeners include methylcellulose, hydroxyethylcellulose and carboxymethylcellulose, and furthermore casein, gum arabic, tragacanth gum, starch, sodium alginate. Preferred acrylate thickeners are selected from one or more of sodium polyacrylates, water-soluble copolymers based on acrylic and (meth)acrylic acid, such as acrylic acid/acrylamide and (meth)acrylic acid/acrylic ester copolymers.

Also, the coating compositions may include thickeners selected from polyvinyl alcohol, associative thickeners, such as styrene/maleic anhydride polymers or preferably hydrophobically modified polyetherurethanes (HEUR) known to a person skilled in the art, hydrophobically modified acrylic acid copolymers (HASE) and polyetherpolyols.

Alkaline organic and/or alkaline inorganic compounds are suitable as neutralizing agents. Also preferred in addition to aqueous ammonia solutions are volatile primary, secondary and tertiary amines, such as ethylamine, dimethylamine, dimethylethanolamine, triethylamine, morpholine, piperidine, diethanolamine, triethanolamine, diisopropylamine, 2-amino-2-methylpropanol, 2-N,N-dimethylamino-2-methyl-propanol and mixtures of these compounds.

The coating mixture has 0.01 to 0.5 wt. % silicone based defoamer. A defoamer or an anti-foaming agent is a chemical additive that reduces and hinders the formation of foam in industrial process liquids. The terms anti-foaming agent and defoamer are often used interchangeably. Commonly used agents are polydimethylsiloxanes and other silicones. The additive is used to prevent formation of foam or is added to break a foam already formed. Silicone-based defoamers are polymers with silicon backbones. The silicone compound consists of an hydrophobic silica dispersed in a silicone oil. Emulsifiers are added to ensure the silicone spreads fast and well in the foaming medium. The silicone compound might also contain silicone glycols and other modified silicone fluids. Polydimethylsiloxane is a preferred antifoaming agent.

The coating mixture has 0 to 10 wt. % pigment. Pigments which may be used are all pigments known to a person skilled in the art for the intended use. Preferred pigments for the aqueous formulations according to the invention, are, for example, titanium dioxide, preferably in the form of rutile, barium sulfate, zinc oxide, zinc sulfide, basic lead carbonate, antimony trioxide and lithopone (zinc sulfide and barium sulfate). However, the aqueous formulations can also contain colored pigments, for example iron oxides, carbon black, graphite, luminescent pigments, zinc yellow, zinc green, ultramarine, manganese black, antimony black, manganese violet, Paris blue or Schweinfurt green. In addition to the inorganic pigments, the formulations according to the invention may also contain organic colored pigments, for example sepia, gamboge, Kasset brown, toluidine red, para red, Hansa yellow, indigo, azo dyes, anthraquinoid and indigoid dyes and dioxazine, quinacridone, phthalocyanine, isoindolinone and metal complex pigments. Titanium dioxide is a preferred pigment. Titanium dioxide used in the invention preferably has an average particle size of 0.7 to 8μ, more preferably 2 to 4μ, most preferably 2.5 to 3.5μ.

The average particle size of the sum of all the inorganic particles in the polymer coating composition is 0.7 to 4 microns, preferably 0.9 to 3.5 microns, most preferably 3 to 3.5 microns. This is also known for purposes of this invention as the combined average particle size of the inorganic particles. The combined inorganic particles in the polymer coating composition include the clay, calcium carbonate, calcium sulfate dihydrate, and any other inorganic particles, for example, pigment, if present.

Moreover, if the combined average particle size of the inorganic particles is above 2 microns then the latex polymer is 1.8 to 5% of the coating composition on a water free (also known as dry) basis.

Also, if the combined average particle size of the inorganic particles is less than 0.8 micron, preferably less than 0.9 micron, then the latex polymer is 1.8 to 2.1% of the coating composition on a water free (also known as dry) basis.

Additives for Gypsum Slurries

Other conventional additives can be employed in the gypsum slurries in the practice of the invention in customary amounts to impart desirable properties and to facilitate manufacturing, such as, for example, aqueous foam, set accelerators, set retarders, recalcination inhibitors, binders, adhesives, dispersants, leveling or non-leveling agents, thickeners, bactericides, fungicides, pH adjusters, colorants, reinforcing materials, fire retardants, water repellants, fillers and mixtures thereof.

The gypsum slurry also optionally includes one or more modifiers that enhance the ability of the dispersant to fluidize the slurry, thus improving its efficacy. Preferred modifiers include cement, lime, also known as quicklime or calcium oxide, slaked lime, also known as calcium hydroxide, soda ash, also known a sodium carbonate, and other carbonates, silicates, phosphonates and phosphates. Dosage of the modifier is from 0.05% to about 1% depending on the modifier being used and the application with which it is used. Additional information on modifiers and their use is found in U.S. Published Patent Application No. US 2006-0280898 A1, entitled “Modifiers for Gypsum Slurries and Method of Using Them”, incorporated by reference.

Preferably the modifiers and the dispersant are added to the mixer water prior to the addition of the calcium sulfate hemihydrate. If both the modifier and the dispersant are in dry form, they can be pre-blended with each other and added with the stucco. A method for adding dispersants and modifiers to a stucco composition is disclosed in more detail in US 2006-0280898 A1, entitled “Modifiers for Gypsum Slurries and Method of Using Them”, incorporated by reference.

Additional additives are also added to the slurry as are typical for the particular application to which the gypsum slurry will be put. Set retarders (up to about 2 lb./MSF (9.8 g/m²)) or dry accelerators (up to about 35 lb./MSF (170 g/m²)) are added to modify the rate at which the hydration reactions take place. Calcium Sulfate Accelerator (“CSA”) is a set accelerator comprising 95% calcium sulfate dihydrate co-ground with 5% sugar and heated to 250° F. (121° C.) to caramelize the sugar. CSA is available from USG Corporation, Southard, Okla. plant, and is made according to U.S. Pat. No. 3,573,947, herein incorporated by reference. Potassium sulfate is another preferred accelerator. HRA is calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. Both of these are preferred accelerators.

Another accelerator, known as wet gypsum accelerator or WGA, is also a preferred accelerator. A description of the use of and a method for making wet gypsum accelerator are disclosed in U.S. Pat. No. 6,409,825, herein incorporated by reference. This accelerator includes at least one additive selected from the group consisting of an organic phosphonic compound, a phosphate-containing compound or mixtures thereof. This particular accelerator exhibits substantial longevity and maintains its effectiveness over time such that the wet gypsum accelerator can be made, stored, and even transported over long distances prior to use. The wet gypsum accelerator is used in amounts ranging from about 5 to about 80 pounds per thousand square feet (24.3 to 390 g/m²) of board product.

The gypsum slurry may include additives to modify one or more properties of the final product. Additives are used in the manner and amounts as are known in the art. Concentrations are reported in amounts per 1000 square feet of finished board panels (“MSF”). Starches are used in amounts from about 3 to about 20 lbs./MSF (14.6 to 97.6 g/m²) to increase the paper bond and strengthen the product. Glass fibers are optionally added to the slurry in amounts of at least 11 lb./MSF (54 g/m²). Up to 15 lb./MSF (73.2 g/m²) of paper fibers are also added to the slurry. Wax emulsions are added to the gypsum slurry in amounts up to 90 lb./MSF (0.4 kg/m²) to improve the water-resistance of the finished gypsum board panel.

To yield voids in the set gypsum-containing product to provide lighter weight, any of the conventional foaming agents known to be useful in preparing foamed set gypsum products can be employed. Many such foaming agents are well known and readily available commercially, e.g., soap. Foams and a preferred method for preparing foamed gypsum products are disclosed in U.S. Pat. No. 5,683,635, herein incorporated by reference. If foam is added to the product, the polycarboxylate dispersant and/or polynaphthalene sulfonate (if employed) is optionally divided between the gauge water and the foam water or two different dispersants are used in the gauge water and the foam water prior to its addition to the calcium sulfate hemihydrate. This method is disclosed in US published patent application 2006-0278128 A1, entitled, “Effective Use of Dispersants in Wallboard Containing Foam”, incorporated by reference.

Other potential additives to the wallboard are biocides to reduce growth of mold, mildew or fungi. Depending on the biocide selected and the intended use for the wallboard, the biocide can be added to the covering, the gypsum core or both. Examples of biocides include boric acid, pyrithione salts and copper salts. Biocides can be added to either the covering or the gypsum core. When used, biocides are used in the coverings in amounts of less than 500 ppm.

In addition, the gypsum composition optionally can include a starch, such as a pregelatinized starch or an acid modified starch. The inclusion of the pregelatinized starch increases the strength of the set and dried gypsum cast and minimizes or avoids the risk of paper delamination under conditions of increased moisture (e.g., with regard to elevated ratios of water to calcined gypsum). One of ordinary skill in the art will appreciate methods of pregelatinizing raw starch, such as, for example, cooking raw starch in water at temperatures of at least about 185° F. (85° C.) or other methods. Suitable examples of pregelatinized starch include, but are not limited to, PCF 1000 starch, commercially available from Lauhoff Grain Company and AMERIKOR 818 and HQM PREGEL starches, both commercially available from Archer Daniels Midland Company. If included, the pregelatinized starch is present in any suitable amount. For example, if included, the pregelatinized starch can be added to the mixture used to form the set gypsum composition such that it is present in an amount of from about 0.5% to about 10% percent by weight of the set gypsum composition. Starches such as USG95 (United States Gypsum Company, Chicago, Ill.) are also optionally added for core strength.

Other known additives may be used as needed to modify specific properties of the product. Sugars, such as dextrose, are used to improve the paper bond at the ends of the boards. Wax emulsions or polysiloxanes are used for water resistance. If stiffness is needed, boric acid is commonly added. Fire retardancy can be improved by the addition of vermiculite. These and other known additives are useful in the present slurry and wallboard formulations.

Thus, in a preferred composition and method for producing a gypsum board, the composition comprises a mixture of calcined gypsum (calcium sulfate hemihydrate), water, polycarboxylate dispersant, trimetaphosphate ion, and a pregelatinized starch.

Foaming Agent

Any of the conventional foaming agents known to be useful in preparing foamed set gypsum products can be employed. A preferred range of foaming agent is from about 0.2 lb/MSF to about 1.5 lb/MSF. Many such foaming agents are well known and readily available commercially, e.g., soap. For further descriptions of useful foaming agents, see, for example: U.S. Pat. Nos. 4,676,835; 5,158,612; 5,240,639 and 5,643,510; and PCT International Application Publication WO 95116515, published Jun. 22, 1995.

In many cases it will be preferred to form relatively large voids in the gypsum product, to help maintain its strength. This can be accomplished by employing a foaming agent that generates foam that is relatively unstable when in contact with calcined gypsum slurry. Preferably, this is accomplished by blending a major amount of foaming agent known to generate relatively unstable foam, with a minor amount of foaming agent known to generate relatively stable foam.

Such a foaming agent mixture can be pre-blended “off-line”, i.e., separate from the process of preparing foamed gypsum product. However, it is preferable to blend such foaming agents concurrently and continuously, as an integral “on-line” part of the process. This can be accomplished, for example, by pumping separate streams of the different foaming agents and bringing the streams together at, or just prior to, the foam generator that is employed to generate the stream of aqueous foam which is then inserted into and mixed with the calcined gypsum slurry. By blending in this manner, the ratio of foaming agents in the blend can be simply and efficiently adjusted (for example, by changing the flow rate of one or both of the separate streams) to achieve the desired void characteristics in the foamed set gypsum product. Such adjustment will be made in response to an examination of the final product to determine whether such adjustment is needed. Further description of such “on-line” blending and adjusting can be found in U.S. Pat. No. 5,643,510, and in U.S. Pat. No. 5,683,635.

An example of one type of foaming agent, useful to generate unstable foams, has the formula ROSO₃⁻M⁺, wherein R is an alkyl group containing from 2 to 20 carbon atoms, and M is a cation. Preferably, R is an alkyl group containing from 8 to 12 carbon atoms. An example of one type of foaming agent, useful to generate stable foams, has the formula CH₃(CH₂)ₓCH₂(OCH₂CH₂)yOSO₃⁻M⁺, wherein X is a number from 2 to 20, Y is a number from 0 to 10 and is greater than 0 in at least 50 weight percent of the foaming agent, and M is a cation. Blends of these foaming agents may also be employed.

In some preferred embodiments of the invention, the aqueous foam has been generated from a pre-blended foaming agent having the formula CH₃(CH₂)ₓ(CH₂(OCH₂CH₂)yOSO₃⁻M⁺, wherein X is a number from 2 to 20, Y is a number from 0 to 10 and is 0 in at least 50 weight percent of the foaming agent, and M is a cation. Preferably, Y is 0 in from 86 to 99 weight percent of this foaming agent.

The following examples are presented to further illustrate some preferred embodiments of the invention and to compare them with methods and compositions outside the scope of the invention. Unless otherwise indicated, concentrations of materials in compositions and mixtures are given in percent by weight based upon the weight of calcined gypsum present.

### Example 1

A goal of these examples was to find a coating that permitted a fast finishing dry wall.

One or more formulations of the tested coatings were made to contain clay filler, calcium carbonate or calcium sulfate dihydrate, polycarboxylate dispersant, 2-amino-2-methyl-1-propanol pH which acts as a modifier and dispersant, cellulose or acrylate thickener, titanium dioxide, and silicone based defoaming agent, with latex of vinyl acetate or vinyl chloride or styrene butadiene. The formulations were rod-applied on the face paper for wallboard product. 3-ply Manila grade face paper was tested. The coating was coated on the outer surface of the face paper at 1.5 to 6 mils to be applied in an amount of 3.6 pounds/MSF on a dry (water free basis).

The coated paper after drying showed no scuffing problems, and could be handled, rolled, and bent as the regular face paper for wallboard production.

TABLEs 1 and 2 show the compositions of the Samples 1-13 tested and the resulting properties. Formulas of Samples 2, 5, 7 and 13 are according to the present invention. The other examples are comparative examples.

The average particle size of the tested calcined clay was about 3.2 microns. The average particle size of the tested water washed clay was about 0.5 microns. The average particle size of the tested precipitated calcium carbonate was about 0.9 microns. The average particle size of the tested ground calcium carbonate was about 3.5 microns. The average particle size of the tested calcium sulfate dihydrate about 3 microns. The average particle size of the TiO2 used as pigment was about 3 microns.

TABLEs 1 and 2 show above the “properties” line, the composition is in wt. % of formulation. TABLEs 1 and 2 show below the “properties” line viscosity in KU. TABLEs 1 and 2 also show below the “properties” line, average air resistance of paper measured in seconds, i.e., the amount of time to pass 100 ml of air through paper. The longer the time, the more blocked by the coating, which will cause issues in the board production because it is difficult to dry the board in the kiln, and will cause production issues. The lower numbers in air resistance are good for production but bad for dust, because too little of latex is used, and the fillers are loose in the coating matrix. TABLEs 1 and 2 also show below the “properties” line, a weighted average particle size of the total of the clay, calcium carbonate and calcium sulfate dihydrate in the coating composition.

TABLE 1
Tests of coatings made from various formulas (All ingredient amounts
in wt. % of total coating).

| Coating formula | SAMPLE | | | | | | |
|---|---|---|---|---|---|---|---|
| Ingredients | 1 | Inventive 2 | 3 | 4 | Inventive 5 | 6 | Inventive 7 |
| Water | 57.93 | 58.59 | 59.43 | 59.43 | 58.59 | 59.43 | 58.59 |
| water washed clay | 10.36 | 10.36 | 10.36 | | | | |
| calcined clay | | | | 10.36 | 10.36 | 10.36 | 10.36 |
| precipitated calcium | 25.90 | 25.90 | 25.90 | | | | |
| carbonate | | | | | | | |
| ground calcium | | | | 25.90 | 25.90 | | |
| carbonate | | | | | | | |
| ground land plaster | | | | | | 25.90 | 25.90 |
| (calcium sulfate | | | | | | | |
| dihydrate) | | | | | | | |
| 2-amino-2-methyl-1- | 0.07 | 0.07 | 0.07 | 0.07 | 0.07 | 0.07 | 0.07 |
| propanol | | | | | | | |
| polycarboxylate | | | | | | | |
| dispersant | | | | | | | |
| cellulous thickener | 0.05 | 0.05 | 0.05 | 0.05 | 0.05 | 0.05 | 0.05 |
| acrylate thickener | | | | | | | |
| titanium oxide | | | | | | | |
| silicon based | 0.04 | 0.04 | 0.04 | 0.04 | 0.04 | 0.04 | 0.04 |
| defomer | | | | | | | |
| vinyl acetate latex | 5.65 | 4.99 | 4.15 | 4.15 | 4.99 | 4.15 | 4.99 |
| (Tg = 30° F.) | | | | | | | |
| vinyl chloride latex | | | | | | | |
| (Tg = 50° F.) | | | | | | | |
| styrene butadiene | | | | | | | |
| latex (Tg = 95° F.) | | | | | | | |
| Properties | | | | | | | |
| Weighted average | 0.79 | 0.79 | 0.79 | 3.41 | 3.41 | 3.06 | 3.06 |
| particle size of clay, | | | | | | | |
| CaCO3, and CaSO4- | | | | | | | |
| dihydrate (μ) | | | | | | | |
| viscosity | 62 KU | 62 KU | 60 KU | 66 KU | 62 KU | 66 KU | 62 KU |
| Average air resistance | 280.00 | 109.00 | 95.00 | 113.00 | 122.00 | 89.00 | 95.00 |
| of paper (TAPPI Test | | | | | | | |
| Method T460 OM-88) | | | | | | | |
| (sec.) | | | | | | | |
| Surface dust (1 to 5 | 1 | 2 | 3 | 1 | 1 | 3 | 2 |
| scale) 1 no dust, 5 | | | | | | | |
| heavy dust | | | | | | | |

TABLE 2
Tests of coatings made from various formulas

| Coating formula | SAMPLE | | | | | |
|---|---|---|---|---|---|---|
| Ingredients | 8 | 9 | 10 | 11 | 12 | Inventive13 |
| Water | 58.59 | 59.43 | 47.80 | 47.80 | 32.87 | 42.77 |
| water washed clay | 10.36 | 10.36 | 19.39 | 19.39 | | |
| calcined clay | | | | | 30.33 | 15.96 |
| precipitated calcium | 25.90 | 25.90 | | | | 31.16 |
| carbonate | | | | | | |
| ground calcium | | | 28.50 | 28.50 | | |
| carbonate | | | | | | |
| ground land plaster | | | | | | |
| (calcium sulfate | | | | | | |
| dihydrate) | | | | | | |
| 2-amino-2-methyl-1- | 0.07 | 0.07 | 0.07 | 0.07 | 0.12 | 0.14 |
| propanol | | | | | | |
| polycarboxylate | | | | | | 0.09 |
| dispersant | | | | | | |
| cellulous thickener | 0.05 | 0.05 | 0.05 | 0.05 | | |
| acrylate thickener | | | | | 0.05 | |
| titanium oxide | | | | | 6.30 | 2.66 |
| silicon based | 0.04 | 0.04 | 0.04 | 0.04 | | |
| defomer | | | | | | |
| vinyl acetate latex | | | | 4.15 | | 7.22 |
| (Tg = 30° F.) | | | | | | |
| vinyl chloride latex | | | | | 30.33 | |
| (Tg = 50° F.) | | | | | | |
| styrene butadiene | 4.99 | 4.15 | 4.15 | | | |
| latex (Tg = 95° F.) | | | | | | |
| Properties | | | | | | |
| Weighted average | 0.79 | 0.79 | 2.28 | 2.28 | 3.17 | 1.75 |
| particle size of clay, | | | | | | |
| CaCO3, CaSO4- | | | | | | |
| dihydrate, TiO2 (μ) | | | | | | |
| viscosity | 62 KU | 60 KU | 60 KU | 60 KU | 62 KU | 63 KU |
| Average air resistance | 89.00 | 95.00 | 95.00 | 95.00 | 136.60 | 136.3 |
| of paper (TAPPI Test | | | | | | |
| Method T460 OM-88) | | | | | | |
| (sec.) | | | | | | |
| Surface dust (1 to 5 | 5 | 5 | 5 | 4 | 1 | 1 |
| scale) 1 no dust, 5 | | | | | | |
| heavy dust | | | | | | |

In TABLEs 1 and 2 the weight of the latex of vinyl acetate or vinyl chloride or styrene butadiene is the weight of the entire latex with water and other ingredients of the latex included. The latexes were aqueous dispersions of about 40 wt % polymer solids.

The data shows the coatings made from the compositions of Samples 2, 5 and 7 achieved preferred combinations of properties. The coatings made from the compositions of Samples 5 and 7 achieved the best combinations of properties.

The invention seeks to minimize the air resistance of the coated paper to permit the paper to breathe so water in the gypsum slurry can escape through the coated paper when the gypsum slurry is being dewatered and dried to set the slurry to make wallboard. Air resistance of the coated paper was measured in a according to the test method TAPPI T460 OM-88, Air Resistance of Paper (Gurley Method) standard by Technical Association of the Pulp and Paper Industry (1988). This determines resistance to air permeability as the time in which a given air volume flows through paper when the air was forced to flow with a controlled pressure through a given area. The porosity of the coated paper of the invention is preferably 140 seconds or less, more preferably 130 seconds or less, according to the TAPPI OM-88 test method.

To facilitate manufacture the invention also seeks to make a coating with a kinematic viscosity that facilitates application of the coating. Preferably this kinematic viscosity is between 60 and 67 Krebs units (ku), more preferably between 61 and 63 ku.

The invention seeks to provide coated paper that can be use as regular face paper to manufacture the wallboard, such that the wallboard can be installed and finished without the first primer coat during the installation process. Thus, the wallboard installer could save one coating in the installation process to save cost in labor and coating materials. Thus, the invention also seeks to minimize dust (visible particles) per an internal scale from 1 to 5, wherein 1 has no dust and 5 has heavy dust. The dust parameter is preferably 3 or less, more preferably is 2 or less on this scale. The dust test is conducted by applying a colored tape to the surface and peeling the tape back at 180° to collect the dust. Then the collected dust on the tape is visually observed and the relative amounts from the various samples were compared. Those with no dust were apparently assigned a value of 1. Thus with very heavy dust were apparently assigned a value of 5. Those with a rating of 2, 3 or 4 were judged on a relative basis with the other tested samples.

Sample 1 was a comparative example. The overall weighted average particle size of the total of the clay, calcium carbonate, and calcium sulfate dihydrate (not present) was calculated as follows: [(10.36/(10.36+25.90))×0.5μ]+[(25.90/(10.36+25.90))×0.9μ]=0.786μ.

Overall weighted average particle size of the total of the clay, the calcium carbonate, and the calcium sulfate dihydrate (not present) was likewise calculated for each example and listed in TABLES 1 and 2.

Samples 2, 5 and 7 of the invention performed well in the air resistance test.

Sample 13 of the invention was adequate but not preferred.

The coatings of Samples 5 and 7 had the best combinations of properties. The coating made from preferred Sample 5 achieved a suitable viscosity and average air resistance together with an exceptional surface dust level of 1. Comparison of Sample 2 and preferred Sample 5 shows employing calcined clay rather than the relatively coarser water washed clay reduced the dust level. The tests show the use of calcined clay rather than the relatively coarser water washed clay led to improved results. The coating made from Sample 7 achieved a suitable viscosity and surface dust level together with an exceptionally low average air resistance of 95 seconds.

Comparative Samples 3, 4 and 6 had too little latex to balance the sizes of its particles.

Comparative Samples 8-10 and 12 employed polymer having too high a Tg.

Comparative Sample 11 had high dusting due to having too little latex polymer.

Although Comparative Sample 12 had some properties comparable to inventive Sample 13. However, Comparative Sample 12 required much more latex and this is undesirable as it adds to costs.

Comparison of results of Comparative Sample 4 and Sample 5 shows maintaining latex level sufficiently above 4.15 wt. % was needed to keep viscosity sufficiently low. Likewise, comparison of results of formula 6 and formula 7 shows maintaining latex level sufficiently above 4.15 wt. % was needed to keep viscosity sufficiently low. However, comparison of Samples 1 (having 5.65 wt. % latex) and 2 shows raising the latex to 5.65 wt. % increases air resistance to an unacceptable level. This shows maintaining latex level sufficiently below 5.65 wt. % helped to keep air resistance sufficiently low. As a result the invention selects a latex level of 4.5 wt. % to 5.5 wt. % for latex of 35 to 50 wt. % polymer solids.

Comparison of Sample 2 and Comparative Sample 8 shows switching from a vinyl acetate latex having a Tg of 30° F. to a latex of styrene butadiene having a Tg of 95° F. dramatically increases dusting to an unacceptable level. This implies the importance of keeping Tg low. As a result the invention selects a Tg of 0 to 35° F., preferably 25 to 32° F.

The invention is not limited by the above provided embodiments but rather is defined by the claims appended hereto.

What is claimed is:

1. A gypsum board comprising:
a face paper sheet having an inner bond surface and an outer surface, the face paper sheet inner bond surface opposed to the face paper sheet outer surface, the face paper sheet treated with a polymer coating composition disposed on the entire outer surface of the face paper sheet to have a polymer coating,
wherein the polymer coating composition comprises a mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
preferably the polycarboxylate dispersant comprises a polycarboxylic ether dispersant,
preferably the naphthalene dispersant is selected from at least one of beta-naphthalene sulfonate, naphthalene sulfonate formaldehyde condensate and sodium naphthalene sulfate formaldehyde condensate,
preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
0.02 to 0.5 wt. % thickener selected from at least one member of the group consisting of a cellulose thickener and an acrylate thickener,
0.01 to 0.5 wt. % silicon based defoamer,
4.5 to 15 wt. %, preferably 4.8 to 6.5 wt. %, more preferably 4.8 to 5.2 wt. %, latex comprising latex polymer having a glass transition temperature (Tg) of 0 to 35° F., preferably 25 to 32° F., the latex polymer having a weight average molecular weight of 40,000 to 500,000, the latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex, the latex comprising 35 to 55 wt. % said latex polymer dispersed as solids in aqueous medium,
inorganic particles, wherein the inorganic particles are 28 to 50 wt. %, preferably 34.5 to 42 wt. %, of the polymer coating composition, wherein the inorganic particles have a combined average particle size of 0.7 to 4 microns, preferably 0.9 to 3.5 microns, most preferably 3 to 3.5 microns,
wherein the inorganic particles comprise,
clay, wherein the clay is 0 to 17 wt. %, preferably 8 to 17 wt. %, more preferably 9.5 to 11 wt. %, of the polymer coating composition, wherein the clay has an average particle size of 0.3 to 3.7 microns, preferably the clay is calcined clay having average particle size of 2.8 to 3.5 microns,
inorganic filler powder, wherein the inorganic filler powder is 20 to 45 wt. %, preferably 20 to 31 wt. %, more preferably 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.7 to 1.2 microns, preferably 0.8 to 1.0 microns, wherein the calcium sulfate dihydrate has an average particle size of 0.7 to 10 microns, preferably 2.5 to 4 microns,
pigment particles, wherein the pigment particles are 0 to 10 wt. %, of the polymer coating composition, preferably the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.8 micron, preferably less than 0.9 micron, then the latex polymer is 1.8 to 2.1% of the coating composition on a water free basis, and
49 to 65 wt. % water, preferably 55 to 61 wt. % water, this water being in addition to water of the latex aqueous medium;
a backing paper sheet having an inner bond surface and an outer surface, the backing paper sheet inner bond surface opposed to the backing paper sheet outer surface;
a foamed gypsum core layer having opposed first and second sides, the foamed gypsum core layer between the face paper sheet inner bond surface and the backing paper sheet inner bond surface, the foamed gypsum core layer comprising calcium sulfate dihydrate, wherein the gypsum core layer has a thickness of 0.25 to 1 inches and a density of 15 to 55 pounds/cubic foot, wherein the foamed gypsum core layer has a total void volume of 30 to 90 volume percent;
wherein the polymer coating penetrates the outer surface of the face paper sheet a depth of 0 to 20% of thickness of the face paper sheet.

2. The board of claim 1, wherein the slurry from which the gypsum core material was made was a mixture of water and calcium sulfate hemihydrate at a water to calcium sulfate hemihydrate weight ratio of 0.2-1.5:1, preferably 0.2-0.8:1, more preferably 0.4-0.7:1,
wherein the board comprises the gypsum core sandwiched between the face paper sheet and a backing paper sheet.

3. The board of claim 1, wherein the porosity of the board is less than 140 seconds according to TAPPI OM-88 test method and kinematic viscosity of the coating composition is 55 to 70 ku.

4. The board of claim 1, wherein the gypsum core material has a total void volume of 35 to 85 volume percent.

5. The board of claim 1, wherein the gypsum board further comprises a first relatively dense gypsum layer comprising calcium sulfate dihydrate, wherein the first relatively dense gypsum layer is between the foamed gypsum core layer and the face paper sheet inner bond surface, wherein opposed sides of the first relatively dense gypsum layer respectively contact the foamed gypsum core layer and the face paper sheet inner bond surface; the first relatively dense gypsum layer having a density greater than density of the foamed gypsum core layer, the first layer of relatively dense gypsum being thinner than the foamed gypsum core layer, wherein the first layer of relatively dense gypsum has a total void volume of less than 30 volume percent, wherein the gypsum core material has a total void volume of 45 to 80 volume percent and the first layer of relatively dense gypsum preferably has a total void volume of less than 10 volume %.

6. The board of claim 1, wherein the latex polymer has a glass transition temperature (Tg) of 5° C. to 30° C.

7. The board of claim 1, wherein the porosity of the board is less than 130 seconds according to TAPPI OM-88 test method.

8. The board of claim 1, wherein the pigment comprises titanium dioxide.

9. The board of claim 1, wherein the polymer coating composition comprises the mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
wherein the polycarboxylate dispersant comprises a polycarboxylic ether dispersant,
wherein the naphthalene dispersant is selected from at least one of beta-naphthalene sulfonate, naphthalene sulfonate formaldehyde condensate and sodium naphthalene sulfate formaldehyde condensate,
wherein the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
the 0.02 to 0.5 wt. % thickener selected from at least one member of the group consisting of a cellulose thickener and an acrylate thickener,
the 0.01 to 0.5 wt. % silicon based defoamer,
4.8 to 5.2 wt. %, said latex comprising latex polymer having a glass transition temperature (Tg) of 25 to 32° F., the latex polymer having a weight average molecular weight of 40,000 to 500,000, wherein the latex polymer comprises polyvinyl acetate latex, the latex comprising 35 to 55 wt. % said latex polymer dispersed as solids in aqueous medium,
wherein the inorganic particles are 34.5 to 42 wt. %, of the polymer coating composition, wherein the inorganic particles have a combined average particle size of 3 to 3.5 microns,
wherein the inorganic particles comprise,
the clay, wherein the clay is 9.5 to 11 wt. %, of the polymer coating composition, wherein the clay has average particle size of 2.8 to 3.5 microns,
the inorganic filler powder, wherein the inorganic filler powder is 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.8 to 1.0 microns, wherein the calcium sulfate dihydrate has an average particle size of 2.5 to 4 microns,
the pigment particles, wherein the pigment particles are 0 to 10 wt. %, of the polymer coating composition, wherein the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.9 micron, then the latex polymer is 1.8 to 2.1% of the coating composition on a water free basis, and
55 to 61 wt. % water, this water being in addition to water of the latex aqueous medium;
the backing paper sheet having an inner bond surface and an outer surface, the backing paper sheet inner bond surface opposed to the backing paper sheet outer surface;
the foamed gypsum core layer having opposed first and second sides, the foamed gypsum core layer between the face paper sheet inner bond surface and the backing paper sheet inner bond surface, the foamed gypsum core layer comprising calcium sulfate dihydrate, wherein the gypsum core layer has a thickness of 0.25 to 1 inches and a density of 15 to 55 pounds/cubic foot, wherein the foamed gypsum core layer has a total void volume of 30 to 90 volume percent;
wherein the polymer coating penetrates the outer surface of the face paper sheet the depth of 0 to 20% of thickness of the face paper sheet.

10. A method of making a gypsum board, comprising:
providing a face paper sheet having an inner bond surface and an outer surface, the face paper sheet inner bond surface opposed to the face paper sheet outer surface, the face paper sheet treated with a polymer coating composition disposed on the entire outer surface of the face paper sheet to have a polymer coating,
wherein the polymer coating composition comprises a mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
preferably the polycarboxylate dispersant comprises a polycarboxylic ether dispersant,
preferably the naphthalene dispersant is selected from at least one of beta-naphthalene sulfonate, naphthalene sulfonate formaldehyde condensate and sodium naphthalene sulfate formaldehyde condensate,
preferably the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
0.02 to 0.5 wt. % thickener selected from at least one member of the group consisting of a cellulose thickener and an acrylate thickener,
0.01 to 0.5 wt. % silicon based defoamer,
4.5 to 15 wt. %, preferably 4.8 to 6.5 wt. %, more preferably 4.8 to 5.2 wt. %, latex comprising latex polymer having a glass transition temperature (Tg) of 0 to 35° F., preferably 25 to 32° F., the latex polymer having a weight average molecular weight of 40,000 to 500,000, the latex polymer is selected from at least one member of the group consisting of polyvinyl acetate latex, polyvinyl acrylate and polyvinyl chloride latex, acrylics, styrene acrylics, acrylic esters, vinyl acrylics, vinyl chloride, vinyl chloride acrylic, styrene acetate acrylics, ethylene polyvinyl acetate, styrene butadiene, and combinations thereof, and surfactant, preferably the latex polymer is selected from at least one member of the group consisting of polyvinyl acetate latex, polyvinyl acrylate and polyvinyl chloride latex, more preferably the latex polymer comprises polyvinyl acetate latex, the latex comprising 35 to 55 wt. % said latex polymer dispersed as solids in aqueous medium,
inorganic particles, wherein the inorganic particles are 28 to 50 wt. %, preferably 34.5 to 42 wt. %, of the polymer coating composition, wherein the inorganic particles have a combined average particle size of 0.7 to 4 microns, preferably 0.9 to 3.5 microns, most preferably 3 to 3.5 microns,
wherein the inorganic particles comprise,
clay, wherein the clay is 0 to 17 wt. %, preferably 8 to 17 wt. %, more preferably 9.5 to 11 wt. %, of the polymer coating composition, wherein the clay has an average particle size of 0.3 to 3.7 microns, preferably the clay is calcined clay having average particle size of 2.8 to 3.5 microns,
inorganic filler powder, wherein the inorganic filler powder is 20 to 45 wt. %, preferably 20 to 31 wt. %, more preferably 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.7 to 1.2 microns, preferably 0.8 to 1.0 microns, wherein the calcium sulfate dihydrate has an average particle size of 0.7 to 10 microns, preferably 2.5 to 4 microns,
pigment particles, wherein the pigment particles are 0 to 10 wt. %, of the polymer coating composition, preferably the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.8 micron, preferably less than 0.9 micron, then the latex polymer is 1.8 to 2.1% of the coating composition on a water free basis, and
49 to 65 wt. % water, preferably 55 to 61 wt. % water, this water being in addition to water of the latex aqueous medium;
mixing water, calcium sulfate hemihydrate and air to make a foamed gypsum slurry, wherein a weight ratio of the water to calcium sulfate hemihydrate being mixed is 0.2-1.5:1, preferably 0.2-0.8:1, more preferably 0.4-0.7:1;
depositing a layer of the foamed gypsum slurry over the face paper sheet inner bond surface;
depositing a backing paper sheet over the layer of the foamed gypsum slurry;
wherein calcium sulfate hemihydrate in the foamed gypsum slurry converts to calcium sulfate dihydrate and sets to form the gypsum board,
wherein the polymer coating penetrates the outer surface of the face paper sheet a depth of 0 to 20% of thickness of the face paper sheet,
wherein a foamed gypsum core layer resulting from the set foamed gypsum slurry has a thickness of 0.25 to 1 inches and a density of 15 to 55 pounds/cubic foot, wherein the foamed gypsum core layer has a total void volume of 30 to 90 volume percent.

11. The method of claim 10, wherein the face paper outer surface is pre-coated with the polymer coating composition to form the polymer layer.

12. The method of claim 10, wherein the face paper unrolls from a roll to be deposited onto a production line for making the gypsum board, further comprising applying the polymer coating composition to the outer surface of the face paper sheet during board manufacture in the time between when the face paper unrolls from the roll and when the face paper is deposited on the production line.

13. The method of claim 10, wherein the polymer coating is applied to the outer side of the face paper sheet after the gypsum core of the board sets.

14. The method of claim 10, wherein the gypsum core material has a total void volume of 35 to 85 volume percent.

15. The method of claim 10, wherein the method of the invention further comprises:
depositing a first layer of relatively dense gypsum slurry comprising water and calcium sulfate hemihydrate directly on the inner bond surface of the face paper sheet to form a first layer of relatively dense slurry, and then the foamed gypsum slurry layer is applied on the first layer of relatively dense gypsum slurry;
wherein calcium sulfate hemihydrate in the relatively dense gypsum slurry converts to calcium sulfate dihydrate, the relatively dense gypsum slurry sets during formation of the gypsum board,
the first relatively dense gypsum slurry having a density greater than that of the foamed gypsum slurry, the first layer of relatively dense gypsum slurry being thinner than the foamed gypsum core layer, wherein the set first layer of relatively dense gypsum resulting from setting the relatively dense gypsum slurry has a total void volume of less than 30 volume percent,
wherein the foamed slurry is deposited directly on the layer of relatively dense slurry to form the foamed gypsum core material.

16. The method of claim 15, wherein the gypsum core material has a total void volume of 45 to 80 volume percent and the set first layer of relatively dense gypsum resulting from setting the relatively dense gypsum slurry has a total void volume of less than 10 volume %.

17. The method of claim 10, wherein the porosity of the board is less than 130 seconds according to TAPPI OM-88 test method.

18. The method of claim 10, wherein the slurry from which the gypsum core material was made was a mixture of water and calcium sulfate hemihydrate at a water to calcium sulfate hemihydrate weight ratio of 0.2-1.5:1, preferably 0.2-0.8:1, more preferably 0.4-0.7:1;
wherein the board comprises the gypsum core sandwiched between the face paper sheet and a back paper sheet.

19. The method of claim 10, wherein the latex polymer has a glass transition temperature (Tg) of 5° C. to 30° C. and kinematic viscosity of the applied latex coating composition is between 60 and 67 Krebs units (ku).

20. The method of claim 10, wherein the polymer coating composition comprises the mixture of
0.05 to 0.25 wt. % 2-amino-2-methyl-1-propanol,
0 to 0.5 wt. % dispersant selected from at least one member of the group consisting of polycarboxylate dispersant, polyphosphate dispersant, and naphthalene dispersant,
wherein the polycarboxylate dispersant comprises a polycarboxylic ether dispersant,
wherein the naphthalene dispersant is selected from at least one of beta-naphthalene sulfonate, naphthalene sulfonate formaldehyde condensate and sodium naphthalene sulfate formaldehyde condensate,
wherein the polyphosphate dispersant is selected from at least one member of the group consisting of sodium trimetaphosphate (STMP), sodium tripolyphosphate (STPP), potassium tripolyphosphate (KTPP), tetrasodium pyrophosphate tetrapotassium pyrophosphate, and tetrapotassium pyrophosphate (TKPP), more preferably the polyphosphate is tetrapotassium pyrophosphate (TKPP),
the 0.02 to 0.5 wt. % thickener selected from at least one member of the group consisting of a cellulose thickener and an acrylate thickener,
the 0.01 to 0.5 wt. % silicon based defoamer,
4.8 to 5.2 wt. %, said latex comprising latex polymer having a glass transition temperature (Tg) of 25 to 32° F., the latex polymer having a weight average molecular weight of 40,000 to 500,000, wherein the latex polymer comprises polyvinyl acetate latex, the latex comprising 35 to 55 wt. % said latex polymer dispersed as solids in aqueous medium,
wherein the inorganic particles are 34.5 to 42 wt. %, of the polymer coating composition, wherein the inorganic particles have a combined average particle size of 3 to 3.5 microns,
wherein the inorganic particles comprise,
the clay, wherein the clay is 9.5 to 11 wt. %, of the polymer coating composition, wherein the clay has average particle size of 2.8 to 3.5 microns,
the inorganic filler powder, wherein the inorganic filler powder is 25 to 31 wt. %, of the polymer coating composition, wherein the inorganic filler powder is selected from at least one member of the group consisting of calcium carbonate and calcium sulfate dihydrate, wherein the calcium carbonate has an average particle size of 0.8 to 1.0 microns, wherein the calcium sulfate dihydrate has an average particle size of 2.5 to 4 microns,
the pigment particles, wherein the pigment particles are 0 to 10 wt. %, of the polymer coating composition, wherein the pigment particles comprises titanium dioxide,
with the proviso that if the combined average particle size of the inorganic particles is above 2 microns then the latex polymer is 1.8 to 5% of the coating composition on a water free basis, and
with the proviso that if the combined average particle size of the inorganic particles is less than 0.9 micron, then the latex polymer is 1.8 to 2.1% of the coating composition on a water free basis, and
55 to 61 wt. % water, this water being in addition to water of the latex aqueous medium;
the backing paper sheet having an inner bond surface and an outer surface, the backing paper sheet inner bond surface opposed to the backing paper sheet outer surface;
the foamed gypsum core layer having opposed first and second sides, the foamed gypsum core layer between the face paper sheet inner bond surface and the backing paper sheet inner bond surface, the foamed gypsum core layer comprising calcium sulfate dihydrate, wherein the gypsum core layer has a thickness of 0.25 to 1 inches and a density of 15 to 55 pounds/cubic foot, wherein the foamed gypsum core layer has a total void volume of 30 to 90 volume percent;
wherein the polymer coating penetrates the outer surface of the face paper sheet the depth of 0 to 20% of thickness of the face paper sheet.
